(19) United States
(12) Patent Application Publication
(10) Pub. No.: US 2019/0206183 A1
(43) Pub. Date: Jul. 4, 2019

(54) GAMING SYSTEM AND METHOD HAVING FREE SPINS WITH CASCADING AND LOOPING WINS

(71) Applicant: ADP GAUSELMANN GMBH, Espelkamp (DE)

(72) Inventors: Charles Hiten, Lighthouse, FL (US); Michael Charles Halvorson, Las Vegas, NV (US)

(73) Assignee: ADP GAUSELMANN GMBH

(21) Appl. No.: 15/983,697

(22) Filed: May 18, 2018

Related U.S. Application Data
(63) Continuation of application No. 15/858,629, filed on Dec. 29, 2017.

(51) Int. Cl. G07F 17/32

(52) U.S. Cl. CPC G07F 17/3213; G07F 17/3258; G07F 17/3227; G07F 17/3267; G07F 17/3248; G07F 17/3246; G07F 17/3251; G07F 17/323; G07F 17/3241; G07F 17/3288

(57) ABSTRACT

Various embodiments of a gaming system and method are disclosed as having a repeating free spin win accumulator associated with unlocked symbol display areas. In one embodiment, the gaming system may include a plurality of symbol display areas. Upon a triggering event, one or more of the symbol display areas are set to an unlocked state for a play of a game. For each symbol display area that is unlocked, the gaming system randomly generates and displays at least one symbol from an associated set of symbols in a predetermined format. The gaming system accumulates awards based on the randomly generated and displayed symbols in the unlocked symbol display areas. The gaming system may lock any symbol display area where the gaming system generated and displayed a lock symbol. In one embodiment, the gaming system repeats the process for the play of a game until all symbol display areas are locked.

### CROSS REFERENCE TO RELATED APPLICATION

This application claims priority to U.S. Non-Provisional application Ser. No. 15/858,629, filed on Dec. 29, 2017, the contents of which are hereby incorporated by reference.

### FIELD OF THE INVENTION

The present disclosure relates to gaming devices.

### SUMMARY OF THE INVENTION

Various embodiments of a gaming system and method are disclosed as having a repeating free spin win accumulator associated with unlocked symbol display areas. In some embodiments, the gaming system accumulates wins in a predetermined format. In some embodiments, the predetermined format for accumulated wins is a waterfall or cascading format.

In one embodiment including the repeating free spin win accumulator, a gaming system may include a plurality of symbol display areas. Upon a triggering event, one or more of the symbol display areas are set to an unlocked state for a play of a game. In some embodiments, the triggering event may include the gaming system generating at least one predetermined triggering symbol. For each symbol display area that is unlocked, the gaming system randomly generates and displays at least one symbol from one or more sets of symbols. Each symbol from the sets of symbols may be associated with an award or value. In some embodiments, each unlocked symbol display area is associated with one set of symbols. In one embodiment, the gaming system randomly generates and displays the at least one symbol for each unlocked symbol display area in a predetermined format. The gaming system may determine if a lock symbol was generated in any of the unlocked symbol display areas. In one such embodiment, where the gaming system determines that lock symbols were generated in unlocked symbol display areas, the gaming system locks such symbol display areas from receiving additionally generated symbols from the sets of symbols for remainder of the game. The gaming system also evaluates the generated symbols in the symbol display area to determine an accumulated award. In some embodiments, if any symbol display areas remain unlocked, the gaming system may repeat the above noted process for the play of the game until all symbol display areas are locked. That is, the gaming system may randomly generate and display at least one symbol for each remaining unlocked symbol display area. In alternative embodiments, if any symbol display areas remain unlocked, the gaming system may repeat the process a predetermined number of times, such as five times (or some alternative suitable number of times). In some embodiments, if any symbol display areas remain unlocked, the gaming system may repeat the process a predetermined number of times based in part on a player's wager or based on part on a triggering event.

In one embodiment including the repeating free spin win accumulator, a gaming system may include a plurality of symbol display areas associated with a plurality of video based slot machine reels. For example, the gaming system may include five video based slot machine reels that are each associated with three symbol display areas. The gaming system further includes a first symbol set that includes a first plurality of symbols. The gaming system generates a plurality of symbols from the first symbol set for the plurality of symbol display areas. The gaming system evaluates the generated plurality of symbols for winning symbol combinations. The gaming system also evaluates the generated plurality of symbols for triggering symbols. If the gaming system determines that at least one triggering symbol was generated, one or more of the symbol display areas are set to an unlocked state for a play of a game. In some embodiments, one triggering symbol may cause the gaming system to unlock symbol display areas associated with one or more of the reels. In an alternative embodiment, the gaming system creates a second set of unlocked symbol display areas (different from the plurality of symbol display areas associated with the plurality of video based slot machine reels) based in part on the quantity of generated triggering symbols.

For each symbol display area that is unlocked, the gaming system randomly generates and displays at least one symbol from an associated second symbol set. In some embodiments, a plurality of symbol display areas share an associated second symbol set. In other embodiments, each unlocked symbol display area is associated with its own second symbol set. Each symbol from the second symbol set may be associated with an award or value. In one embodiment, the first symbol set and the second symbol set include different symbols. In alternative embodiments, the first and second symbol set include the same symbols. In one such embodiment, the gaming system randomly generates and displays the at least one symbol for each unlocked symbol display area in a waterfall or cascading format. The gaming system evaluates the generated symbols in the symbol display area to determine an accumulated award based on the symbols generated for the unlocked symbol display areas. The gaming system may also determine if a lock symbol was generated in any of the unlocked symbol display areas. For example, the gaming system may be configured to evaluate the symbol associated with a lowest value award in the second symbol set as a lock symbol. In other embodiments, the lock symbol may have no value and can be any suitable symbol. When the gaming system determines that one or more lock symbols were generated in unlocked symbol display areas, the gaming system locks such symbol display areas from receiving additionally generated symbols from the second symbol set for remainder of the game. In some embodiments, if any symbol display areas remain unlocked, the gaming system may repeat the above process for the play of the game until all symbol display areas are locked. That is, the gaming system may repeat randomly generating and displaying at least one symbol for each remaining unlocked symbol display area from the second symbol set, evaluate the generated symbols for awards, and lock any relevant unlocked symbol display areas in one or more loops until all symbol display areas are locked.

In alternative embodiments, if any symbol display areas remain unlocked, the gaming system may repeat the process a predetermined number of times, such as five times (or some alternative suitable number of times) for the play of the game. In some embodiments, if any symbol display areas remain unlocked, the gaming system may repeat the process a predetermined number of times based in part on a player's wager or based on part on a triggering event for the play of the game.

In some embodiments, the gaming system initiates the repeating free spin win accumulator based on as few as one triggering symbol. In some embodiments, the gaming system is configured to generate the at least one triggering symbol frequently. In some embodiments, the amount available for a player to win in the repeating free spin win accumulator game is not predetermined. In some embodiments, the gaming system is configured to include only winning values or positive values in the second symbol set. In some embodiments, the more a player wagers on a game, the gaming system is configured to increase the quantity of high value symbols that are available for the repeating free spin win accumulator portion of the game. It should therefore be appreciated that a gaming system and method with a repeating free spin win accumulator creates new and very exciting ways for a player to obtain winning symbols with a potential to earn frequent and greater awards. With every play of the repeating free spin win accumulator gaming system resulting in payouts and with frequent entries into the game, such a gaming system can be highly volatile and extremely exciting for players. The new potential to earn greater awards creates a greatly improved sense of anticipation for players.

### BRIEF DESCRIPTION OF THE DRAWINGS

FIG. 1 is a perspective view of one embodiment of a stand-alone gaming device of a gaming system.

FIG. 2 is a functional block diagram of the gaming device technology components of the gaming system.

FIGS. 3A, 3B, and 3C illustrate one embodiment of a method of operating the gaming system including a repeating free spin win accumulator.

FIGS. 4A, 4B, 4C, 4D, 4E, 4F, 4G, 4H, 4I illustrate screen shots of one embodiment of a gaming system comprising a repeating free spin win accumulator.

FIGS. 5A, 5B, 5C, 5D, 5E, 5F, 5G, 5H, 5I, 5J, 5K, 5L illustrate one embodiment of a gaming system comprising a repeating free spin win accumulator.

FIGS. 6A and 6B illustrate one embodiment of a gaming system comprising a repeating free spin win accumulator with a cascading or waterfall win.

FIG. 7 illustrates another embodiment of a gaming system comprising a repeating free spin win accumulator with an alternative cascading or waterfall win.

FIG. 8 illustrates one embodiment of a pay table for a repeating free spin win accumulator.

### DETAILED DESCRIPTION OF THE INVENTION

Various embodiments of a gaming system and method are disclosed as having a repeating free spin win accumulator associated with unlocked symbol display areas. In some embodiments, the gaming system accumulates wins in a predetermined format. In some embodiments, the predetermined format for accumulated wins is a waterfall or cascading format.

In one embodiment including the repeating free spin win accumulator, a gaming system may include a plurality of symbol display areas. Upon a triggering event, one or more of the symbol display areas are set to an unlocked state for a play of a game. In some embodiments, the triggering event may include the gaming system generating at least one predetermined triggering symbol. For each symbol display area that is unlocked, the gaming system randomly generates and displays at least one symbol from a set of symbols. Each symbol from the set of symbols may be associated with an award or value. In one embodiment, the gaming system randomly generates and displays the at least one symbol for each unlocked symbol display area in a predetermined format. The gaming system may determine if a lock symbol was generated in any of the unlocked symbol display areas. In one such embodiment, where the gaming system determines that one or more lock symbols were generated in unlocked symbol display areas, the gaming system locks such symbol display areas from receiving additionally generated symbols from the set of symbols for remainder of the game. The gaming system also evaluates the generated symbols in the symbol display area to determine an accumulated award. In some embodiments, if any symbol display areas remain unlocked, the gaming system may repeat the process for the play of the game until all symbol display areas are locked. That is, the gaming system may randomly generate and display at least one symbol for each remaining unlocked symbol display area. In alternative embodiments, if any symbol display areas remain unlocked, the gaming system may repeat the process a predetermined number of times, such as five times (or some alternative suitable number of times). In some embodiments, if any symbol display areas remain unlocked, the gaming system may repeat the process a predetermined number of times based in part on a player's wager or based in part on a triggering event.

### Gaming Device Platform

The features and advantages of the gaming system and method described herein may be provided to a player via a gaming device platform that includes various structures and components for allowing player interaction with the gaming device. While only one gaming device platform will be described in detail herein, the features, objects, and advantages of the gaming system described herein may be implemented in one or more alternative gaming device platforms.

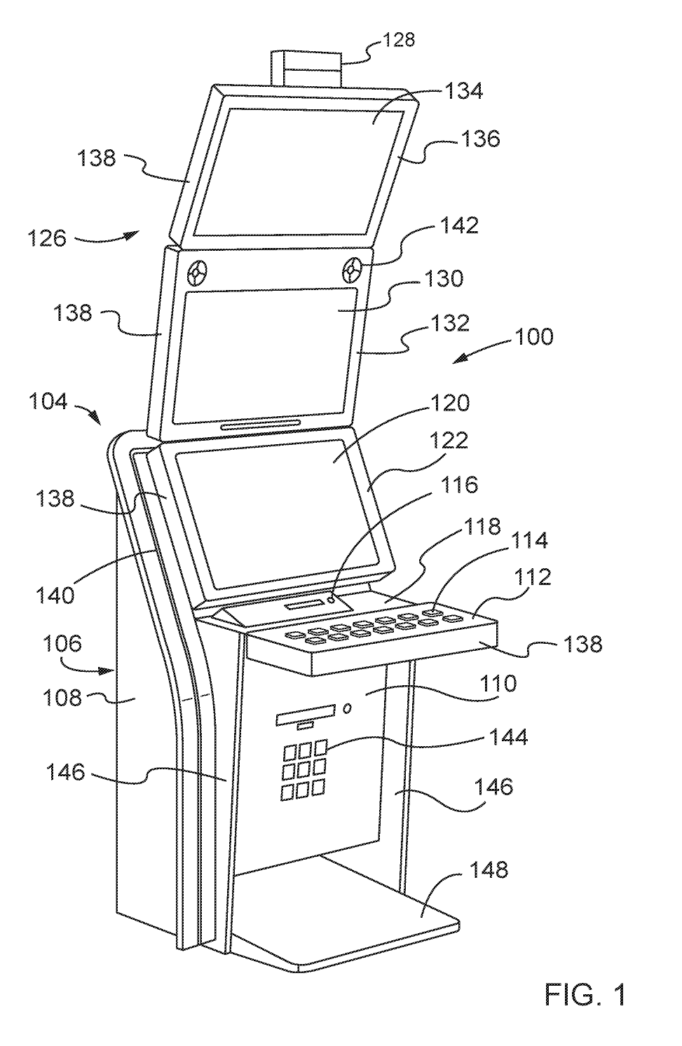

One embodiment of a gaming device platform is shown in FIG. 1 where a gaming device 100 is generally shown. In one embodiment, the gaming device 100 is referred to as a slot machine and is illustrated as housed in a housing or cabinet constructed so that a player can operate and play the gaming device 100 while standing or sitting.

Gaming device 100 may include cabinet 104 for housing the components fully described hereinbelow. The cabinet 104 has a lower cabinet body portion 106 which includes a pair of cabinet side panels 108 (only one of which is viewable in the perspective view of FIG. 1), front panel 110, and a rear panel (not shown). A base panel (not shown) and a top panel surface (not shown) that supports first game display 120 and the player interaction area 112, are provided. The cabinet panels are interconnected along their edges and cooperate to form a cabinet enclosure for housing the gaming device, as can be seen in FIG. 1.

It should be appreciated that a wide variety of cabinet enclosure sizes, shapes, and designs are possible for the gaming device 100. Cabinet 104 may function to securely protect any local control system, technology components, and provide support for game display(s) and player input and output interactions with the gaming device.

Returning to FIG. 1, the gaming device enables the player to interact with the gaming device 100 to direct the wagering and game play activities and preferences. Various forms of player interaction devices and activities will now be described.

Cabinet 104 includes a player interaction area having input and output areas generally designated as 112. The player interaction area 112 may be located on the front top side of cabinet 104 and, as shown, on a panel structure that extends outwardly from the gaming device in a player's direction. Player interaction area 112 may contain a plurality of player input and output structures such as player control button area 114, player value acceptor and dispenser area 116, and player convenience input area 118.

Player control button area 114 includes a plurality of buttons, touch sensitive areas, or both through with which players may interact with the one or more processors of gaming device 100 and direct game play. It is expected that cabinet 104 provides an easily accessible location and support for all necessary player input/output (I/O) interactions with the device, including gaming control interactions and value wagering interactions. Although the gaming device 100 illustrated in FIG. 1 shows player controls provided by buttons of player control button area 114, it is understood that in one embodiment, a player's gaming control interactions could be made by either buttons mounted on cabinet 104 or “soft” buttons located on the gaming display and activated by player touch (e.g., touch screen interfaces), or a combination of both arrangements.

Player control button area 114 may include, for example: game selection button(s) in any embodiments where more than one game is provided in a single gaming device; gaming denomination value selection button(s) in any embodiments where one or more wagering denomination value is accommodated; wager selection button(s) for the player to indicate or select the desired wager value for a game in any embodiments where a selection of wager values are offered; pay line selection button(s) for selecting the number of active pay lines in game embodiments that provide multiple pay line wagering; a reel spin button for players to initiate one or more reels to spin in a game; a repeat last bet button for players to conveniently repeat the last game's preference and wager selections in a new game; a cash-out button for player extraction of gaming device credits; an attendant call button; and gaming device information buttons such as show pay tables, show game rules, or show other game-related information. As discussed above, the functions of the buttons in player control button area 114 may be duplicated with soft buttons in the player control button area 114 or as soft buttons in other areas of the gaming device 100 (e.g., as a touch screen overlay over available game displays).

Gaming device 100 may include one or more forms of value acceptance and value distribution to allow the player to interact with the device and to risk or otherwise place a wager (a monetary value) on one or more outcomes of a game. Winnings may be returned to the player via some form of value distribution. As illustrated in FIG. 1, player value acceptor and dispenser area 116 is provided. In the player value acceptor and dispenser area 116, a player supplies monetary value to the gaming device 100 via one or more value acceptor devices. In one embodiment, the player value acceptor and dispenser area 116 (through the one or more value acceptor devices) may accept any one or more of the following from a player to establish a gaming credit balance: coins, bills, tokens, tickets/vouchers, player ID cards, credit cards, or other suitable forms of value. Thus, if the gaming device 100 accepts coins and bill, the gaming device 100 includes a currency bill validator and a coin validator as the value acceptor devices. Likewise, if the gaming device 100 accepts tickets, the gaming device includes a ticket acceptor as a value acceptor device for receiving tickets or vouchers representing some monetary value. The ticket acceptor may include a bar code reader, or other appropriate code reader, for reading the encoded value contained by the player's ticket or voucher. In some embodiments, the player value acceptor and dispenser area 116 may include a value acceptor device that can accept more than one type of value. In some embodiments, the player value acceptor and dispenser area 116 may include multiple different value acceptor devices to accept different types of value from players

Upon receipt of some type of value from the player, a value acceptor device of the player value acceptor and dispenser area 116 performs validation on the player supplied value using appropriate hardware readers (e.g., determining that the currency bills/coins/tokens are genuine or the ticket/voucher is genuine). If the validation result is positive on player supplied value, the appropriate value acceptor device generates a signal to a processor of the gaming device 100 to establish a gaming credit balance for plays of one or more games on gaming device 100.

In one embodiment, a player receives monetary value, or a representation thereof, from the gaming device 100 when a player chooses to “cash out” the gaming credit balance (e.g., remove value from the gaming device 100). The player can cash out at any suitable time. When a player cashes out the value contained on a credit meter (not shown) of gaming device 100, a processor of gaming device 100 may cause a printer of gaming device 100 to print and dispense a coded ticket or voucher through a dispensing slot to the player. The coded ticket or voucher may be a bar-coded ticket or any other suitable code (PDF417 coding or quick response (QR) coding). This ticket can then be used as value input at another gaming device, or converted to currency at a conveniently located kiosk or cashier counter located near the gaming device. Alternatively, the processor of gaming device 100 may cause a currency bill dispenser or a coin dispenser in gaming device 100 to dispense the value contained on the credit meter of gaming device 100.

Various combinations of the above value acceptance and value distribution arrangements are possible. Gaming device 100 may include other value acceptance and value distribution mechanisms in the player value acceptor and dispenser area 116. For example, gaming device 100 may include a magnetic strip or chip card reader/writer in order to accept value from and transfer value to a magnetic strip or an embedded chip card. In other embodiments, hardware for transferring (and receiving) non-traditional currencies to players such as digital currencies (e.g., bitcoin) may be included in gaming device 100.

In an alternative embodiment, gaming device 100 may include a card reader (not illustrated) in the in the player value acceptor and dispenser area 116, which accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming device may be associated with the player account. It is noted that a numeric or alphanumeric keypad may be provided adjacent to the card reader slot to enable player entry of a personal identification number or the like for secure access to card information.

In one embodiment, a player convenience input area 118 may be included in the gaming device 100, as is shown in FIG. 1. In various embodiments, player convenience input area 118 may have a variety of features and functions depending on the jurisdictional deployment of the gaming device 100. In one embodiment, the player convenience input area 118 will house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into a gaming device during play. These player loyalty/player tracking cards are associated with a player account and are utilized by the card-issuing entity to monitor, or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain embodiments, the player convenience input area 118 may include player convenience features such as a pocket for storage that allows players to store their personal items such as a mobile phone. Gaming device 100 may include one or more universal serial bus (USB) ports that enables a player to charge their electronics or connect to services such as the Internet or food service. Further, player convenience input area 118 of gaming device 100 may include buttons to request food or drink service if the gaming device is located in an establishment that has food and drink service. The gaming device 100 may be connected to a local or wide area network such that selection of the requested food or drink service will alert the establishment's hospitality staff to deliver the requested service directly to the gaming device 100.

The layout of the player control button area 114, player value acceptor and dispenser area 116 and the player convenience input area 118 in gaming device 100 may be arranged differently than those disclosed and illustrated herein. The selections and arrangement of input locations on the cabinet 104 may be dependent upon the game buttons, the type of value wagered, and the player conveniences utilized in the deployment configuration of gaming device 100.

With continuing reference to FIG. 1, in one embodiment, lower cabinet body portion 106 includes a first game display 120 mounted atop or flush with the lower cabinet body portion's top panel surface. First game display 120 is, for example, a 27-inch liquid crystal display (LCD) display mounted in a widescreen orientation. However, any suitable display may be used in any suitable orientation. In the illustrated embodiment, the first game display 120 is mounted within and framed by first display frame 122 which is, in turn, mounted upon lower cabinet body portion's top panel surface. In this manner, the first game display 120 is both surrounded and secured within the first display frame 122 and raised above the cabinet's top panel surface. Additional features of the first display frame 122 will be described below. In one embodiment, gaming device 100 may use one first game display 120 and not include additional game displays (not illustrated).

The lower cabinet body portion 106 is further constructed to support upper cabinet portion 126. Upper cabinet portion 126 may be comprised of an upwardly extending support structure (not illustrated) that extends upwardly from the rear side of lower cabinet body portion 106 and is sufficiently strong to support one or more additional game displays.

At the topmost end of the support structure, a cabinet top light 128 may be provided. The cabinet top light 128 is capable of illumination in a variety of colors and is utilized to indicate and communicate gaming device conditions to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In one embodiment, as illustrated in FIG. 1, gaming device 100 includes two additional displays, second game display 130 and third game display 134. Second game display 130 and third game display 134 are disposed generally in a vertical relationship and generally in alignment with the first game display 120. Like the first game display 120, second game display 130 and third game display 134 can be 27-inch LCD displays and can be mounted in a widescreen orientation in one embodiment. However, any suitable display in any suitable orientation may be used for the second game display 130 and the third game display 134. Further, like the first game display 120, second game display 130 and third game display 134 can be mounted within and framed by second display frame 132 and third display frame 136, respectively. Second display frame 132 and third display frame 136 are attached to the upper cabinet support structure and can protect the second game display 130 and the third game display 134.

First game display 120, second game display 130, and third game display 134 can be disposed at an angle from each other to form a player-facing concave arc. However, in some embodiments, the angles between the displays may be adjustable and may be smaller or greater than the angles illustrated in FIG. 1. Further, it is understood that in some embodiments the displays may be disposed in a common plane relative to each other.

It also should be appreciated that in various embodiments a variety of display technology may be utilized equivalently and interchangeably with a variety of embodiments of the gaming device. Equivalent display devices include all variations of liquid crystal displays, light emitting diode displays, and plasma displays.

In some embodiments, different sized displays may be combined to display gaming data on gaming device 100. As a non-limiting example, a 27-inch widescreen LCD display may be combined with a 20-inch portrait oriented LCD or a light emitting diode (LED) display. This combination may be used, for example, with a third scrolling banner LED display. In alternative embodiments, one, two, three, or more displays could be used in a variety of positions and orientations. Any suitable combination may be used. It should also be appreciated that a processor of gaming device 100 may communicate with the disclosed first game display 120, second game display 130, and third game display 134 through a video card of gaming device 100 to produce the visible aspects of a game.

In one embodiment, one or more of the first game display 120, second game display 130, and third game display 134 may be fitted with a transparent touch sensitive overlay for sensing player touch inputs into the gaming device. Touch sensitive overlays can communicate with a processor of gaming device 100 to enable the player to interact with the game.

In some embodiments, the curved displays may be used for any or all of the first game display 120, second game display 130, or third game display 134. Similarly, any of the displays used for gaming device 100 can be based on flexible display technologies. For example, it is possible to utilize flexible display technologies to create uniquely shaped curving, wavy, or tubular display structures to provide one or more of the first game display 120, second game display 130, and third game display 134. Additionally, in one embodiment flexible display technologies can be used in combination with fixed flat screen technologies.

While the gaming device 100 has been described as implemented with video technologies, in one embodiment, mechanical reels with reel strips containing game indicia and step motor controllers may be employed to provide game information to a player. In one embodiment, the reel strips may include a plurality of printed symbols. In another embodiment, the mechanical reels may include flexible video display technology as the reel strips on mechanical reels. Thus, games implemented in video form can readily be implemented with mechanical reels utilizing such display technology. Alternatively, in other embodiments mechanical reels with reels strips having fixed symbols displayed along the reel strip could be used to implement the game.

Dependent upon the particular gaming device housing style, a variety of other display technologies may be utilized in combination with the gaming device disclosed herein. For example, in some embodiments a gaming device may have one or more display devices in addition to the main game display(s). For example, the gaming device may include a player tracking device having a player tracking display which displays various information to the player regarding the player's status. The gaming device may also include other game-related displays such as the wager display and the gaming credit balance display. These additional game-related displays may be separate display devices or may be displayed on any one or more of the first game display 120, the second game display 130, or the third game display 134.

Cabinet lighting design functions to attract players to a gaming device 100. In the embodiment of FIG. 1, attractive cabinet lighting is provided by frame accent lighting 138. It is noted that frame accent lighting 138 is a common structure found on each of the first display frame 122, the second display frame 132, and the third display frame 136 and player interaction area 112. Example areas where frame accent lighting is applied to gaming device 100 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In one embodiment, the circuit boards are flexible circuit boards. These LED strips and transparent or translucent coverings may surround one or more gaming device displays frames, as well as the player interaction area, to highlight these areas.

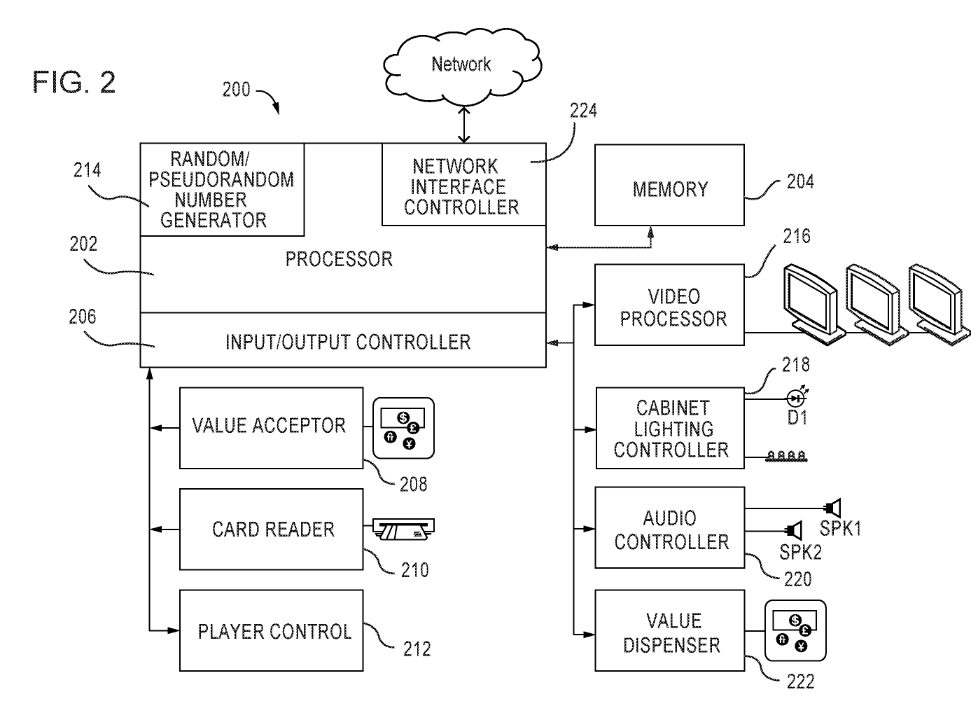

In one embodiment, the individual LEDs mounted on the LED strips are of a type that can emit red, green, and blue light. In an alternative embodiment, separate LEDs are used for each required light color. All LED strips can be electrically connected and can be controlled by a cabinet lighting controller 218 (illustrated in FIG. 2) in conjunction with a processor of gaming device 100 to selectively mix the emitted light colors in a manner to create any color. The cabinet lighting controller 218 can flash and vary lighting as desired. For example, cabinet edge lighting can change and flash in combination with music rhythms or in combination with game events. Other variations are possible.

In some embodiments, cabinet 104 may include LED strip lighting or LED rope lighting to accentuate the cabinet and enhance the attractiveness of gaming device 100 to players. LED rope lighting is a plurality of small light-emitting diode bulbs linked together and encased in a plastic, polyvinylchloride, or other suitable material to create a string of lights. For example, in the embodiment of FIG. 1, cabinet 104 includes cabinet accent lighting 140. In one embodiment, cabinet accent lighting 140 is LED rope lighting mounted flush with the front side edge of the cabinet side panels 108. The LED rope lighting can generate any of suitable colors, and are controlled by cabinet lighting controller 218 and a processor of gaming device 100 to selectively mix the emitted light colors in a manner to create any color in the same manner as the frame edge lighting.

In various embodiments, gaming device 100 includes one or more audio speakers and appropriate driving electronics and sound cards so that game players may experience pleasing audio aspects of the gaming device 100. Audio is desirable to attract and maintain player interest in gaming device 100. Gaming device 100 may also emit attraction sounds during any idle period of gaming device 100. Game audio may add to the player's enjoyment of gaming device 100 by providing music and sound effects designed to enhance and compliment the gaming experience.

Audio speaker hardware may include one or more speakers disposed in or on the cabinet 104 of gaming device 100. In FIG. 1, a pair of audio speakers 142 are shown mounted on the upper corners of second display frame 132. Any suitable number of additional speakers may be provided on additional display frames or on the lower cabinet body portion 106 as desired.

Speakers designed for emitting bass vibrations may be included in some embodiments. Speaker placement may be selected to enhance the sound emitting characteristics of the gaming device. For example, bass speakers or additional speakers 144 may be mounted inside lower cabinet body portion 106. Further, it is envisioned that in some embodiments sound processing such as multichannel processing and surround sound processing are included in gaming device 100. Audio jacks for attachment of player headphones may also be provided in some embodiments of gaming device 100 for the player to further enhance the audio experience of the game and also to block out noise from other gaming devices.

In one embodiment, front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 146 which serve to define a space below player interaction area 112 for players to place their feet and legs while they are playing gaming device 100 in a seated position. Foot rest 148, which may be cushioned, is provided below player interaction area 112 to enhance a player's ergonomic comfort while playing gaming device 100. In one embodiment, the edges of player interaction area 112 may be ergonomically cushioned as well.

Gaming device 100 may be embodied in alternative gaming device housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 104 which can comprise a variety of shapes, sizes, and forms. The cabinet 104 can 1) protect and house the operational electronics, 2) adequately support the display(s) in a position easily viewable for a seated or standing player, as necessary 3) provide an easy location and support for all necessary player input/output (I/O) interactions, including gaming control interactions and value wagering interactions. For example, in some embodiments the gaming device 100 may be disposed in a housing style referred to as a “slant top” gaming device that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In one embodiment, housing styles of cabinet 104 of gaming device 100 may include bar top or table top housing arrangements. These housings are generally small enough to be placed on top of an existing bar or table while providing the requisite gaming device housing functions of protection of/access to gaming electronics, displays, and player I/O functions described above.

In one embodiment, cabinet 104 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

Turning now to FIG. 2, the features and advantages of the gaming system described above will now be described in terms of the various technology components for allowing player interaction with the gaming device 100.

FIG. 2 illustrates a functional block diagram of an embodiment of technology components of gaming device 100 that are specially configured to carry out the game function and operations described herein. The functional elements shown in FIG. 2 cooperate, on a broad and general level, to function as gaming device 100. The subject matter and functional operations described in relation to FIG. 2 can be embodied in hardware, software, or a combination thereof. Described hardware includes the structures described and their functional or operational equivalents. Described functions may be performed by hardware, digital circuitry, computer software, computer firmware, or functionally equivalent combinations thereof.

In one embodiment, gaming device 100 is functionally controlled by control unit 200. Control unit 200 is specifically configured and functions to perform all aspects of operations for providing the game. Control unit 200 includes at least one specially configured processor and at least one controller configured to operate with at least one memory device and at least one data storage device, at least one input device, and at least one output device. In one embodiment, control unit is also configured to communicate with a server device through a network.

In one embodiment, control unit 200 includes at least one specially configured processor 202 or central processing unit (CPU). In one embodiment, specially configured processor 202 include arithmetic logic units and math co-processors also known as floating point units. In one embodiment, specially configured processor 202 includes registers for holding instructions or other data, and cache memory for storing data for faster operation thereupon. In one embodiment, specially configured processor 202 may be a multi-core processor that includes two or more processors for enhanced performance, more efficient parallel processing, or other advantageous computing functions. In another embodiment, specially configured processor 202 may be one or more processing devices such as microprocessor(s) or integrated circuit(s) and may include one or more controllers. It should be appreciated that in some embodiments, a general purpose processor could be programmed to perform the functions of specially configured processor 202.

A controller, in one embodiment, is a device or a software program that manages or directs the flow of data between two entities. Often, controllers are special purpose circuitry or software that solve a technical communications problem between different technology systems. In one embodiment, a controller functions as an interface between two systems while managing the communications between the systems. In another embodiment, a controller functions as an interface between a processor and a peripheral device and functions to control the peripheral device.

At least one specially configured processor 202 or controller of control unit 200 is specially configured to communicate with at least one memory device, generally shown as memory device 204 in FIG. 2. In one embodiment, memory device 204 includes one or more memory structures for storing instructions and various types of game data. Memory structures include one or more random access memory units (RAMs) units, one or more read only memory units (ROMs), one or more flash memory units including solid state drives (SSDs), one or more electrically erasable/programmable read only memory units (EEPROMs).

It should be appreciated that in one embodiment, communication with a memory device by a processor or a controller encompasses the processor or controller accessing the memory device, exchanging data with the memory device, or storing data to the memory device.

Memory device 204 may store all program code and game code (collectively the “code”), and operation data necessary for the operation of the gaming device 100 and execution of the gaming features described hereinbelow. In an alternative embodiment, game code and operation data necessary for the operation of the gaming device 100 may be store in a distributed manner such that some code is stored in memory device 204 and other code is stored remotely from gaming device 100. In one embodiment, the code and operation data necessary for the operation of the gaming device includes, for example, basic input and output function data, instruction fetching data, bus and network communication protocol data, and like data necessary for an operational gaming device 100. In one embodiment, the code and operation data necessary for the execution of the gaming features includes, for example, game image data, game rule data, pay table data, game mode and timing data, gaming value and wager parameter data, and random or pseudo-random number generation data.

In addition to the memory device 204 described above, in one embodiment, the code and operation data for the operation of the gaming device described above may be stored in removable game cartridges or flash drives, a compact disk ROM, a digital versatile disk (DVD) optical storage technology, or suitable other fixed non-transitory storage mediums. In another embodiment, part or all of the code and operational data for operation of the gaming device or for execution of the game features may be stored in a remote memory structure and be downloaded to the memory device 204 via a network connection.

In one embodiment, the gaming device 100 may utilize any combination of memory devices such as random access memory devices (RAMs), unalterable memory devices (ROMs), and mass storage devices for securely storing and securely communicating the software components or code that facilitate game play and other functions of the gaming device 100. The memory devices may store software components or code that include various game data and game related control and execution software. In some embodiments, the software components stored in the memory devices may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the gaming device 100.

In some embodiments, the memory devices, such as memory device 204, with the software components and other data may be secured and authenticated by authentication software stored in an unalterable memory device within the housing of gaming device 100. The gaming device 100 may also include application specific integrated circuits (ASICs) to perform the security and authentication functions. At any appropriate time, such as before each play of a game, at a predetermined interval, upon transfer of any game data or any software components from a mass storage to memory device 204, or upon demand, the gaming device 100 (using a processor such as processor 202 or a separate ASIC) may execute an authentication routine and perform an authentication of any software component or other data of the gaming device 100. In one embodiment, the gaming device software components may be prepared for authentication via creation and storage of an encrypted signature unique to one or more of the software components.

In one embodiment, an encrypted signature may be created by utilizing a hash function on a software component or code to form a message digest (i.e., a hash of the software component) followed by a key encryption of the message digest to form an encrypted signature unique to the software component. In some embodiments, the key encryption may be public key encryption, private key encryption, or any suitable key encryption schema. The encrypted signature may be stored with the gaming device software component, for example, in a mass storage device or an unalterable memory. During a software component authentication, the gaming device 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and gaming device 100 may allow game play to proceed. However, when the message digests do not match, the gaming device 100 may determine that the software component under authentication may be corrupted or fraudulent and game play may be halted. It should be appreciated that the gaming device 100 may perform other suitable security and authentication checks on the game data or software components. Such authentication and security devices and functions are unique to gaming and casino industry to minimize or prevent fraud in gaming devices and gaming systems.

For a player to interact with gaming device 100, control unit 200 receives and processes player inputs, and control unit 200 causes processed results to be output or communicated to the player. In one embodiment, player inputs are recognized and processed or directed for processing by input/output (I/O) controller 206. Further, I/O controller 206 may process and direct player outputs for communication to the player. I/O controller 206 can function as the intermediary between the specially configured processor 202 and one or more input devices to control information and data flow therebetween. I/O controller 206 may also function as the intermediary between the specially configured processor 202 and one or more output devices to control information and data flow therebetween. I/O controller 206 is configured to understand the communication and operational details (such as hardware addresses) for each attached input device and output device. In this manner, specially configured processor 202 is freed from the operational details of the peripheral I/O devices. For example, in one embodiment where an input or output device is changed or upgraded, I/O controller 206 can be changed without changing other gaming system 100 components.

In one embodiment, a player deposits value into gaming device 100 by inserting some form of currency into a value acceptor 208 for game play. Alternatively, a player deposits value into gaming device 100 by inserting an encoded paper ticket into a value acceptor 208 for game play in one embodiment. Value acceptor 208 can be combined with a currency reader and validator, and a code reader for reading value encoded on paper tickets. Value acceptor 208 may read, validate and communicate the amount of the inserted value to the specially configured processor 202. Specially configured processor 202 can establish a gaming credit balance for the player based on the communication from the value acceptor 208. Specially configured processor 202 can also communicate the player's credit balance on a credit balance display of gaming device 100. During game play, each time a player risks a wager on an outcome, specially configured processor 202 processes the wage and determines the amount of credits to debit from the player's credit balance. When a winning outcome is obtained, specially configured processor 202 is configured to determine the amount of credits to add to the player's credit balance.

As previously mentioned with respect to FIG. 1, a variety of value acceptance arrangements are possible. In one embodiment, the value acceptor 208 could include magnetic strip or chip card readers to accept and transfer value. Value acceptor 208 may also be configured to accept and transfer non-traditional currencies such as digital currencies. In these embodiments, I/O controller 206, a specially configured processor 202, or both contain appropriate control instructions to communicate and extract value from the inserted item containing value. In one embodiment, use of a magnetic strip or embedded chip card, for example a bank card, for value insertion requires specially configured processor 202 to communicate, via network interface controller 224 (described below), with devices external to the gaming device 100.

In one embodiment, card reader 210 may be included in gaming device 100 to accept player loyalty cards. For example, card reader 210 can extract account identifying information from the card and utilizes this information to access the associated account information stored remotely via network interface controller 224. In embodiments where player loyalty/player tracking systems are employed, a player's loyalty account and record of gaming activity can be stored in a networked storage location or database. Specially configured processor 202 is configured to record the player's gaming activity in memory device 204 during the duration of loyalty card insertion. When the loyalty card is removed from card reader 210, recorded gaming activity is uploaded, via network interface controller 224, to the remote storage location associated with the player's account. In this manner, the player's gaming activity can be further processed and analyzed, and the player can be awarded loyalty rewards based upon his activity data.

In various embodiments, player control 212 receives a player's game inputs and communicates the player's game inputs to specially configured processor 202. The player's game inputs may include, but are not limited to, wager amounts, pay line selections, game control signals, and cash-out signals. The player control 212 may generate signals based on button presses, touch screen activations, or voice control. The player initiated signals are propagated to the specially configured processor 202 by I/O controller 206. Further, the player initiated signals may direct and inform execution of the game instructions stored in memory device 204 and configured to be executed by specially configured processor 202.

In one embodiment, specially configured processor 202 is configured to execute stored program code and instructions which generate random numbers or pseudo-random numbers. In one embodiment, as illustrated in FIG. 2, a random number generator (RNG) 214 is a software module configured to be executed by specially configured processor 202 for the generation of a true random or pseudo-random number. The code for RNG 214 may be stored in memory device 204. RNG 214 generates random numbers for use by the gaming software during game execution. In one embodiment, random numbers are utilized by game software for the random selection of one or more game symbols from a set of game symbols during a game. As a non-limiting example, the set of game symbols can include numbers, letters, geometric figures, symbols, images, character, animations, blank symbols (e.g., the absence of symbols), or any other suitable graphical depiction. In various embodiments, once random symbols are selected based upon the random number generated by RNG 214, patterns of symbols are compared to determine wagering outcomes. In an alternative embodiment, gaming device 100 may include a hardware based random number generator that is in communication with specially configured processor 202 to supply random numbers for game generation purposes. The hardware based random number generator may be incorporated into specially configured processor 202 or can be separate from specially configured processor 202.

In yet another embodiment, random generation of “numbers” or symbols may be performed with electro-mechanical components. For example, gaming devices such as gaming device 100 may incorporate a plurality of mechanical reels rotatable about a common axis. A plurality of indicia or symbols may be positioned around the periphery of the plurality of reels. Each of the indicia or symbols on each reel may indicate separate detectable reel stop positions. The reels can be set into a spinning/rotation motion by pulling a lever or pushing a button. In some embodiments, the gaming device 100 can stop the reels by the gaming device 100 actuating, on a random timing basis, a suitable mechanical or electro-mechanical reel brake. When the reels stop rotating, one or more displayed stop positions of each reel is detected. Since the stop positions are each associated with an indicia or symbol, the gaming device can determine whether the combination of stop positions (i.e., translating to a combination of displayed symbols) results in a winning symbol combination.

Returning to FIG. 2, control unit 200 controls the function and output of a plurality of output devices utilized by gaming device 100. In various embodiments, I/O controller 206 serves as an interface unit between specially configured processor 202 and output devices such as video processor 216, cabinet lighting controller 218, audio controller 220, and value dispenser 222.

In one embodiment, video processor 216 communicates with specially configured processor 202 to render all game graphics, video displays, and information on gaming device 100's one or more video display units. In one embodiment, video processor 216 includes one or more processors, controllers, and/or graphics cards for processing the game images, outcomes, and animated displays and coordinating the processed data to be display between, among, or across any or all display devices. In various embodiments, this may include being configured to simulate objects and the movement of objects which represent video reels containing sets of gaming symbols.

It should be appreciated that in certain other embodiments where physical mechanical reels are utilized by the gaming device 100 as a game displays, reel controllers and stepper motors would be provided in lieu of or in addition to video processor 216.

In embodiments which utilize cabinet lighting as described with respect to FIG. 1, a cabinet lighting controller 218 may be utilized to coordinate and control the color and timing of cabinet lighting displays with specially configured processor 202. In certain embodiments which utilize sound design, specially configured processor 202 may utilize audio controller 220 to coordinate and control the sound emissions. In one embodiment, audio controller 220 may include one or more audio processing cards for generating sound and for driving the one, two or more speakers that may be included with gaming device 100.

In various embodiments, players may collect remaining credit value by initiating a signal via player control 212 which is communicated to specially configured processor 202 via I/O controller 206. The signal triggers a readout of the player's credit amount and specially configured processor 202 initiates a value dispensing signal which, in turn, is communicated to value dispenser 222. In one embodiment, value dispenser 222 can be controlled to issue the player's credit value using any of the types of value discussed herein. In some embodiments, the player's credit value may be issued to the player via a printed and dispensed encoded paper ticket or token which the player can then exchange at a special purpose kiosk or cashier location for the monetary value encoded into the ticket or token. In some embodiments, the specially configured processor 202 can direct the value dispenser 222 to issue to the player an appropriate amount of coin or bills directly to the player. Additionally, or alternatively, in some embodiments, the player may have the option to electronically direct the credit value to an account associated with the player.

In some embodiments, control unit 200 of gaming device 100 may communicate with one or more devices outside the gaming device 100. For example, gaming device 100 may be connected to a larger gaming network via a local area network (LAN) or a wide area network (WAN). Control unit 200 may communicate with one or more central servers, controllers, or remote devices to execute games, establish credit balances, participate in jackpots, etc. In such embodiments, network communications and connections are accomplished via a network interface controller 224. Network interface controller 224 can be a digital circuit board or card installed in control unit 200 to provide network communications with external devices.

In some embodiments, various additional features and functions are performed by control unit 200. For example, control unit 200 may be specially configured with appropriate software to track all game play events that occur on gaming device 100. In some embodiments, control unit 200 may audit all recorded monetary transactions, including all wager amounts, game outcomes, game winnings, and game payouts that occur through gaming device 100. Further, some embodiments may include security software to assist in protecting the gaming device 100 from tamper or alteration attempts.

Game Including Designated Symbols that Trigger Game Functions and Provide Payout Awards

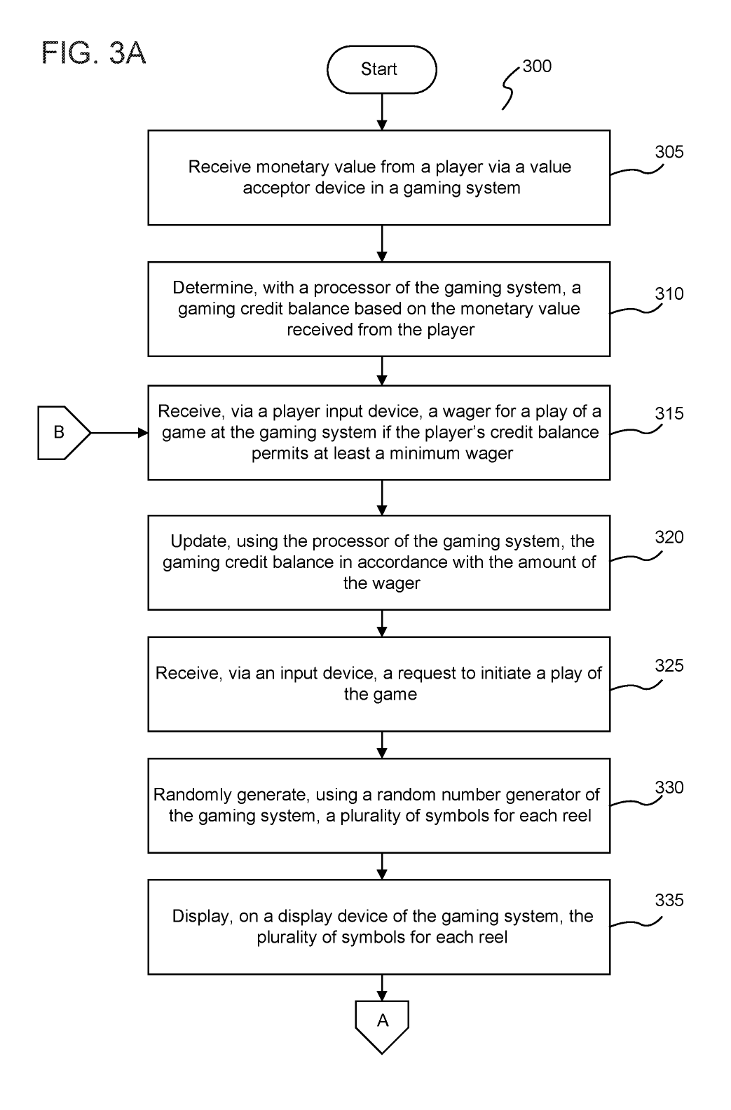

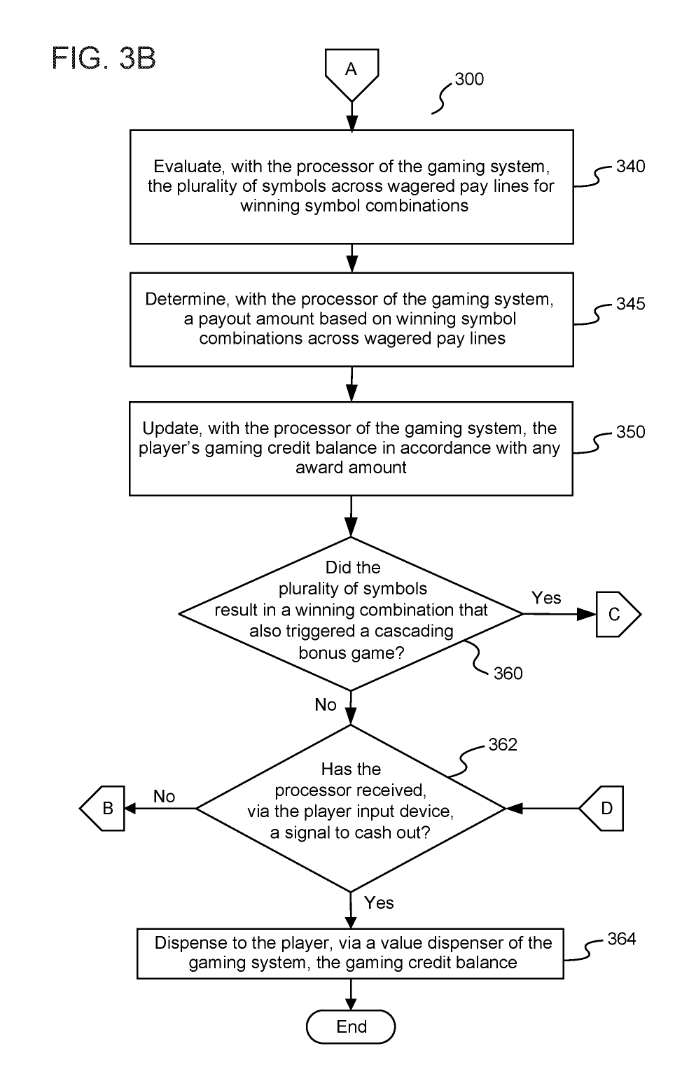

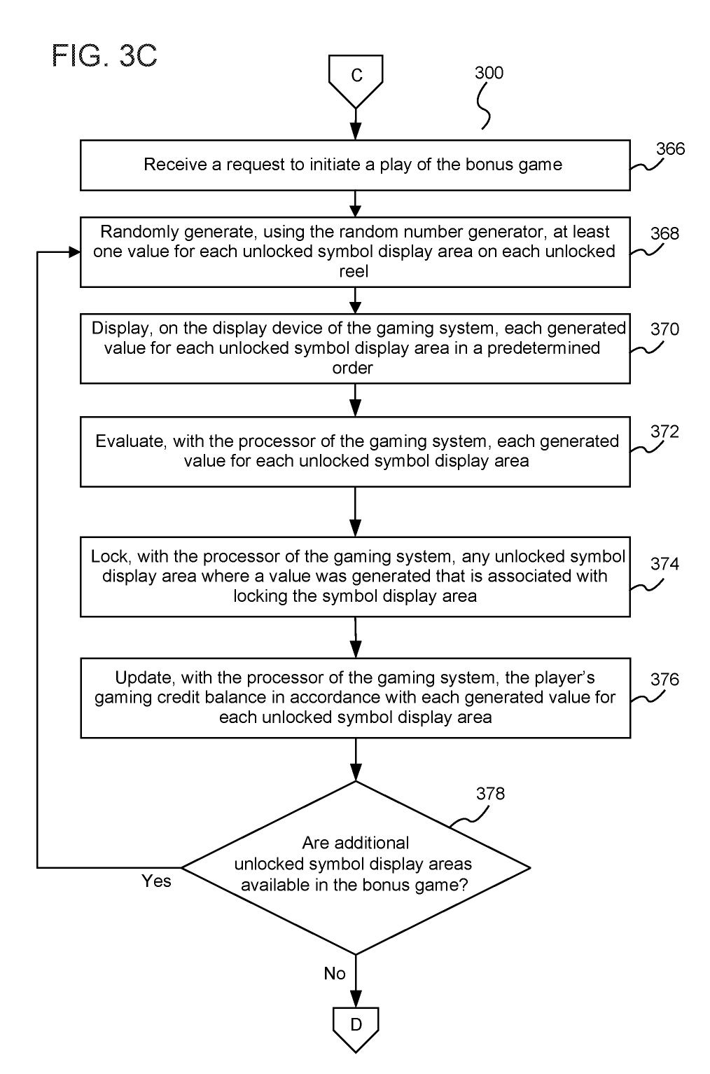

FIGS. 3A, 3B, and 3C illustrate a flowchart of an example operation 300 of one embodiment of the gaming system and method. FIGS. 3A and 3B are depicted as a base or primary game while FIG. 3C is depicted as a bonus game. However, it should be appreciated that FIG. 3C may be integrated as part of a base game without entering a separate bonus game.

In one embodiment, a processor of the gaming system is configured, via instructions stored in a memory device, to perform the operation 300. However, it should be appreciated that other suitable variations of operation 300 are possible. For example, in one embodiment, fewer or one or more additional blocks (not shown) may be employed in operation 300 of the gaming system and method. In other embodiments, the blocks may be performed in any suitable order.

FIG. 3A illustrates one embodiment in which the gaming system receives a monetary value from a player to initiate operation 300. As indicated in block 305, the gaming system may receive monetary value via a value acceptor device associated with the gaming system. The value acceptor device, in one embodiment, is disposed in a gaming system or in communication with the gaming system as discussed above.

In one embodiment, the gaming system determines a credit balance based on the monetary value received from the player at a value acceptor device as indicated in block 310. The gaming system determines, via a processor, a gaming credit balance for the player. The gaming credit balance may be based on the monetary value received from the player at the value acceptor device.

In one embodiment, the gaming system may receive a wager for a play of a game at the gaming system. Block 315 of FIG. 3A illustrates one embodiment where the player's wager is received via a player input device. The gaming system may allow a player to place a minimum wager, a maximum wager, or any suitable wager amount. Depending on the wager amount, the gaming system may also enable the player to select pay lines across displayed symbol positions on reels in a game in which to place wagers. Although in some embodiments, the gaming system selects the wagered pay lines automatically based on the player's wager. Wagered pay lines may be referred to herein as active pay lines. In one embodiment, the gaming system may determine whether the player provided enough credits to enable the player's selected wager. The gaming system may prevent the player from placing the wager and starting a play of a game if the player's credit balance is not large enough to support the player's selected wager. If enough credits are not available in the player's credit balance, the gaming system enables the player to insert additional value to obtain the minimum credit level or to cash out of the gaming system.

In one embodiment, the gaming system may use a processor of the gaming system to update a gaming credit balance. The credit balance may be updated in accordance with the player's wager amount as indicated in block 320. Some embodiments, the credit balance is not updated until a later time.

Block 325 illustrates one embodiment in which the gaming system may receive a request to initiate a play of a game. The request to initiate the play of the game may be received from a player via a player input device in communication with the gaming system. The gaming system may securely access game data from a memory device and execute an authentication routine on the game data to start a play of a game as discussed above. For example, the player may press a spin button on the gaming system to start spinning slot machine reels of the gaming system (or randomly generating symbols using other methods discussed above for virtual reels) for the play of the game. It should be appreciated that reels used throughout the specification may refer to mechanical reels, electro-mechanical reels, or virtual video reels (where virtual reels strips or no reel strips are used). It should further be appreciated that although many examples illustrated in the specification describe the games in terms of slot machines with reels, other games may be used, including games without slot machine reels.

In one embodiment, the gaming system may use a random number generator to randomly generate a plurality of symbols from a set of symbols as indicated in block 330. In one embodiment, at least some of the symbols in the set of symbols are classified or associated with a symbol type. In some embodiments, the gaming system may generate the plurality of symbols for display on a set of reels (or virtual reels). As used herein, the random number generation may refer to pseudo-random or true-random number generation depending on the module used for the random number generation.

In one embodiment, the gaming system may cause a display device to display the plurality of symbols generated as indicated in block 335. In a game using reels, the gaming system may display the generated plurality of symbols in visible symbol display areas of each of the reels. Off page connector A refers to FIG. 3B to continue operation 300.

Turning now to FIG. 3B and off page connector A, in one embodiment as shown in block 340, the gaming system evaluates the generated plurality of symbols across active or wagered pay lines for winning symbol combinations. In some embodiments, the gaming system evaluates the winning symbol combinations based on the pay lines wagered upon by a player. The gaming system may evaluate the player selected pay lines, gaming system assigned pay lines, or pay lines assigned as active in some other manner for the play of the game. In one embodiment using reels, the gaming system determines an award amount based on winning symbol combinations formed across the reels on active pay lines. For example, if a pay table associated with the gaming system indicated that at least three of the same bar symbols is a winning symbol combination and awards a predetermined payout, the gaming system would evaluate the generated plurality of symbols for bar symbols. If the gaming system generated at least three bar symbols on adjacent reels and along an active pay line, the gaming system may determine that the three bar symbols is a winning symbol combination based on the predetermined pay table. It should be appreciated that a pay table may include any suitable number of winning symbol combinations and payouts. In one embodiment, a pay table may indicate that as few as one symbol may be associated with a payout. Alternatively, two or more symbols may be used to form winning symbol combinations that result in a payout.

In block 345, the gaming system determines, with the processor, a payout amount based on the evaluated winning symbol combinations across wagered pay lines. As illustrated in block 350, the gaming system may update, with the processor, the player's gaming credit balance in accordance with any award amount. As noted above, the blocks illustrated in FIGS. 3A-3C can be rearranged in any suitable order. As such, it should be appreciated that the gaming system may update player's gaming credit balance at other suitable times.

In one embodiment, as indicated in block 360, if the gaming system determined that the generated plurality of symbols did not result in triggering a bonus game, operation 300 moves to block 362.

In one embodiment, as indicated in block 362, the gaming system may receive a signal to end game play or “cash out” via an input device of the gaming system. In such a situation, the gaming system dispenses a value to the player, through a value dispenser, based on the player's gaming credit balance as illustrated in block 364 and operation 300 ends.

On the other hand, if the gaming system processor has not received a signal to end game play via the player input device, the process of operation 300 returns to block 315 via off page connector B. The gaming system may receive, via a player input device, a wager for another play of the game and continue operation 300 from block 315. However, in one embodiment, the wager may not be accepted if the player has fewer credits than the player's selected wager amount as shown in block 315.

Returning now to block 360, if the gaming system determined that the generated plurality of symbols resulted in trigging a bonus game, operation 300 moves to block 366 in FIG. 3C via off page connector C. In one embodiment, if the gaming system determines that the generated plurality of symbols includes one or more generated predetermined symbols, the gaming system will trigger or active the bonus game. In one embodiment, the predetermined symbol is a symbol that serves one function: to trigger the bonus game. In alternative embodiments, the predetermined symbol serves a plurality of game functions, such as triggering the bonus game and providing an award value. Other suitable game functions may be associated with the predetermined symbol.

In some embodiments, generating different quantities of the predetermined symbol cause the gaming system to trigger different bonus game features. For example, in one embodiment, if the gaming system generated one predetermined symbol, the gaming system may activate a bonus game with one or more unlocked symbol display areas. An unlocked symbol display area is a symbol display area that the gaming system can use to associate and display at least one generated symbol from the bonus symbol set. A locked symbol display area is a symbol display area that the gaming system cannot associate or display any additional generated symbols from the bonus symbol set. In one embodiment, if the gaming system generated one predetermined symbol, the gaming system may activate a bonus game with one unlocked reel (or three unlocked symbol display areas). In another embodiment, if the gaming system generated one predetermined symbol, the gaming system may activate a bonus game with two unlocked reels (or six unlocked symbol display areas). In some embodiments, when the gaming system generates more predetermined symbols, the gaming system will accordingly unlock more reels (or unlock more symbol display areas). It should be appreciated that the ratio of generated predetermined symbols to unlocked symbol display areas or unlocked reels can be set to any suitable ratio. It should also be appreciated that in some embodiments, events other than generating one or more of a predetermined symbol may trigger the bonus game.

In some embodiments, the gaming system may generate one predetermined symbol on average, 1 in 45 spins. In some embodiments, the gaming system may generate two predetermined symbols on average, 1 in 90 spins. In some embodiments, the gaming system may generate three predetermined symbols on average, 1 in 120 spins. However, it should be appreciated that any suitable ratios can be used.

Block 366 of FIG. 3C illustrates one embodiment in which the gaming system may receive a request to initiate a play of the bonus game. As noted above, the features discussed in connection FIG. 3C may also be applied to primary games or games that are not bonus games. The request to initiate the play of the bonus game may be received from a player via a player input device in communication with the gaming system. For example, the player may press a spin button on the gaming system to start randomly generating symbols for the play of the bonus game. In an alternative embodiment, the processor of the gaming system may automatically initiate the play of the bonus game and randomly generate symbols for the play of the game.

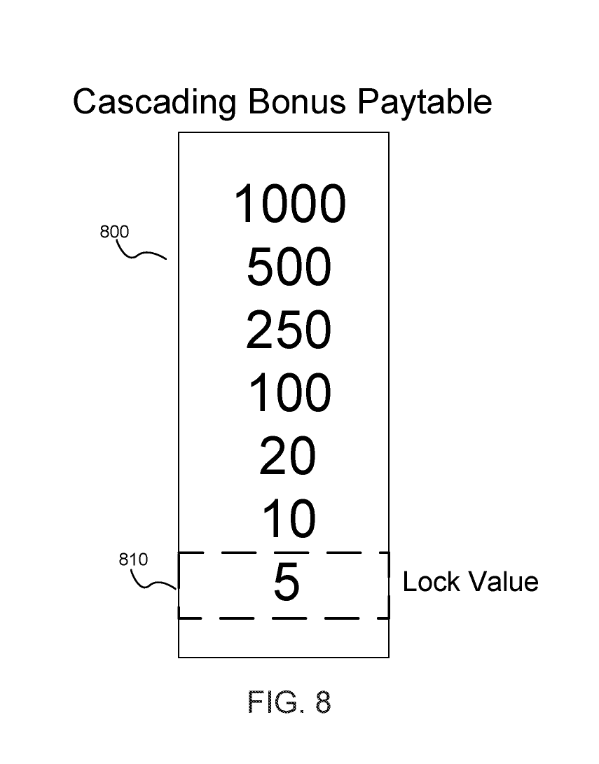

In one embodiment, the gaming system uses a random number generator to randomly generate a plurality of symbols from one or more bonus symbol sets for the bonus game as indicated in block 368. For embodiments without a bonus game, the gaming system randomly generates the plurality of symbols from one or more second symbol sets. In some embodiments, the bonus symbol set comprises one or more symbols that are different from the symbols from the primary game's symbol set. In some embodiments, the bonus symbol set comprises the same symbols from the primary game's symbol set. In some embodiments, the bonus symbol set comprises symbols that are each associated with an award value. In some such embodiments, the symbols in the bonus symbol set are award values such as illustrated in FIG. 8. In FIG. 8, the listed award values 1000, 500, 250, 100, 20, 10 and 5 in pay table 800 each represent an award in a bonus symbol set that the gaming system can randomly generate for plays of the bonus game. In one embodiment, the gaming system generates one symbol from the bonus symbol set for each of the unlocked symbol display areas. In some embodiments, each unlocked reel is associated with a bonus symbol set, where each of the bonus symbol sets may be the same or different. In some embodiments, each unlocked symbol display area is associated with its own bonus symbol set, where each of the bonus symbols set may be the same or different. In some embodiments, each bonus symbol set may be represented by a video slot machine reel. Thus, in some embodiments where each unlocked symbol display area is associated with an individual bonus symbol set and each bonus symbol set is a video slot machine reel, the bonus symbol sets may be uni-reels.

As also indicated in block 368, the gaming system may associate each of the generated plurality of symbols from the bonus symbol set with one of the unlocked symbol display areas. In some embodiments where the unlocked symbol display areas are associated with one or more unlocked reels, the gaming system may associate each of the generated plurality of symbols from the bonus symbol set with one of the unlocked symbol display areas for each unlocked reel.

The gaming system may cause the display device to display the plurality of symbols generated from the bonus symbol set as indicated in block 370. The gaming system may display the generated plurality of symbols (from the bonus symbol set) in associated unlocked symbol display areas of each of the unlocked reels of the gaming system. In one embodiment, the gaming system displays the generated symbols from the bonus symbol set in associated unlocked symbol display areas in a predetermined order. In some embodiments, the gaming system displays the generated symbols in a waterfall or cascading order across the unlocked symbol display areas. For example, the gaming system may sequentially display each of the generated symbols from one side of the game screen to the other in unlocked symbol display areas. However, it should be appreciated that the gaming system may display the generated symbols in the unlocked symbol display areas in any suitable manner.

In one embodiment, the gaming system generates and displays the plurality of symbols generated from the bonus symbol set in unlocked symbol display areas sequentially and in a predetermined order. That is, in one such embodiment, the gaming system generates and displays one of the plurality of symbols from the bonus symbol set in one of the unlocked symbol display areas before generating and displaying another one of the plurality of symbols from the bonus symbol set for a different one of the unlocked symbol display areas. In other embodiments, the gaming system generates and displays the plurality of symbols generated from the bonus symbol set in unlocked symbol display areas non-sequentially and in a random order. In some embodiments, the gaming system generates all of the necessary plurality of symbols from the bonus symbol set before displaying one of the generated necessary plurality of symbols. In some embodiments, as the gaming system displays each generated symbol, the gaming system keeps the generated symbol displayed as each subsequent generated symbol is revealed on the display. In alternative embodiments, the gaming system displays each generated symbol, then obscures the displayed symbols before the next symbol is displayed.

In one embodiment as shown in block 372, the gaming system evaluates the generated plurality of symbols from the bonus symbol set associated with unlocked symbol display areas. In one embodiment, the generated plurality of symbols from the bonus symbol set are each associated with an award value. In one embodiment, the award values are all greater than zero. However, in other embodiments, the award values may include zero or other suitable values. In some embodiments, the symbols from the bonus symbol set are associated with other types of awards, such as additional generations of random symbols for the symbol display areas, free games, free spins, non-monetary prizes, etc. In some embodiments, the gaming system evaluates the generated symbols from the bonus symbol set for winning symbol combinations. That is, the gaming system may evaluate the generated symbols from the bonus symbol set as discussed above in the base or primary game.

Returning to the evaluation of block 372, the gaming system may evaluate the generated symbols against an associated pay table (e.g., where generated symbols do not readily translate into award values). The gaming system's evaluation may also result in calculating the award accumulated based on the generated symbols in the unlocked symbol display areas. In some embodiments, the gaming system accumulates or calculates the awards associated with the unlocked symbol display areas as each symbol is revealed. In alternative embodiments, the gaming system calculates the awards associated with the unlocked symbol display areas all at once. In some embodiments where the gaming system generated each of the plurality of symbols for the unlocked symbol display areas all at once (prior to revealing the generated symbols on the display), the gaming system may calculate the total award prior to displaying the symbols to the player.

In some embodiments, the gaming system further evaluates the generated symbols from the bonus symbol set for an associated status as a lock symbol. A lock symbol appearing in an associated symbol display area causes the gaming system to lock the associated symbol display area from receiving additionally generated symbols from the bonus symbol set for the remainder of the game. In one embodiment, the lock symbol is designated as the lowest value symbol in the bonus symbol set (e.g., the 5 symbol in FIG. 8). In another embodiment, the lock symbol is designated as the highest value symbol in the bonus symbol set (e.g., the 1000 symbol from FIG. 8). However, any suitable symbol from the bonus symbol set can be designated as the lock symbol. Since the lock symbol may be associated with a value, the gaming system may still provide an award to the player associated with the locked symbol display area even if the lock symbol is generated. In some embodiments, a symbol designated as a lock symbol does not lock an associated symbol display area until after the gaming system generated a predetermined quantity of symbols from the bonus symbol set for the associated unlocked symbol display area. That is, in some embodiments, even if a lock symbol is generated for an unlocked symbol display area, the lock symbol may not lock the symbol display area the first one or more times the lock symbol is generated for that symbol display area.

At block 376, the gaming system may update, with the processor, the player's gaming credit balance in accordance with any obtained award amount from the generated symbols from the bonus symbol set. As noted above, the blocks illustrated in FIGS. 3A-3C can be rearranged in any suitable order. As such, it should be appreciated gaming system may update player's gaming credit balance at other suitable times.

At block 378, the gaming system determines whether additional unlocked symbol display areas remain in the bonus game. If unlocked symbol display areas remain, then the operation 300 may return to block 368 to continue with the play of the game and to generate additional symbols from the bonus symbol set for the unlocked symbol display areas. That is, in some embodiments, the gaming system may execute blocks 368, 370, 372, 374, 376, and 378 until no unlocked symbol display areas remain, where executing blocks 368, 370, 372, 374, 376, and 378 once is one cycle. In some embodiments, the symbol display areas remain unlocked for a predetermined quantity of cycles. For example, the gaming system may permit five cycles (or some other suitable number) for each initially unlocked symbol display area in the bonus game. In such an embodiment with a predetermined quantity of random generations, the lock symbol may not be used. In an alternative embodiment, the lock symbol is used after the five random generations. That is, in such an embodiment with a predetermined quantity of random generations (or cycles), the lock symbol may not be used during the first five random generations for each originally unlocked symbol display area, but can be used to stop the bonus game after the first five random generation cycles by locking down the unlocked symbol display areas.

It should be appreciated that the player may cash out at any time, even if unlocked symbol display areas remain. In some embodiments, the player loses the unlocked symbol display areas in the bonus game by cashing out early (e.g., before all symbol display areas are locked in the bonus game). In other embodiments, the player retains the unused and unlocked symbol display areas for application to future bonus games. For example, if the player triggers a bonus game with one unlocked reel, but stored an unused and unlocked reel from a prior bonus game, the gaming system may unlock two reels for the bonus game.

If no unlocked symbols remain as determined at block 378 in FIG. 3C, then the operation 300 may proceed via off page connector D and return to block 362 in FIG. 3B. As indicated in block 362, the gaming system may receive a signal to end game play or “cash out” via an input device of the gaming system. In such a situation, as illustrated in block 364, the gaming system dispenses a value to the player through a value dispenser based on the player's gaming credit balance and operation 300 ends.

On the other hand, if the gaming system processor has not received a signal to end game play via the player input device, the process of operation 300 returns to block 315 via off page connector B. The gaming system may receive, via a player input device, a wager for another play of the game and continue operation 300 from block 315. However, in one embodiment, the wager may not be accepted if the player has fewer credits than the player's selected wager amount as shown in block 315.

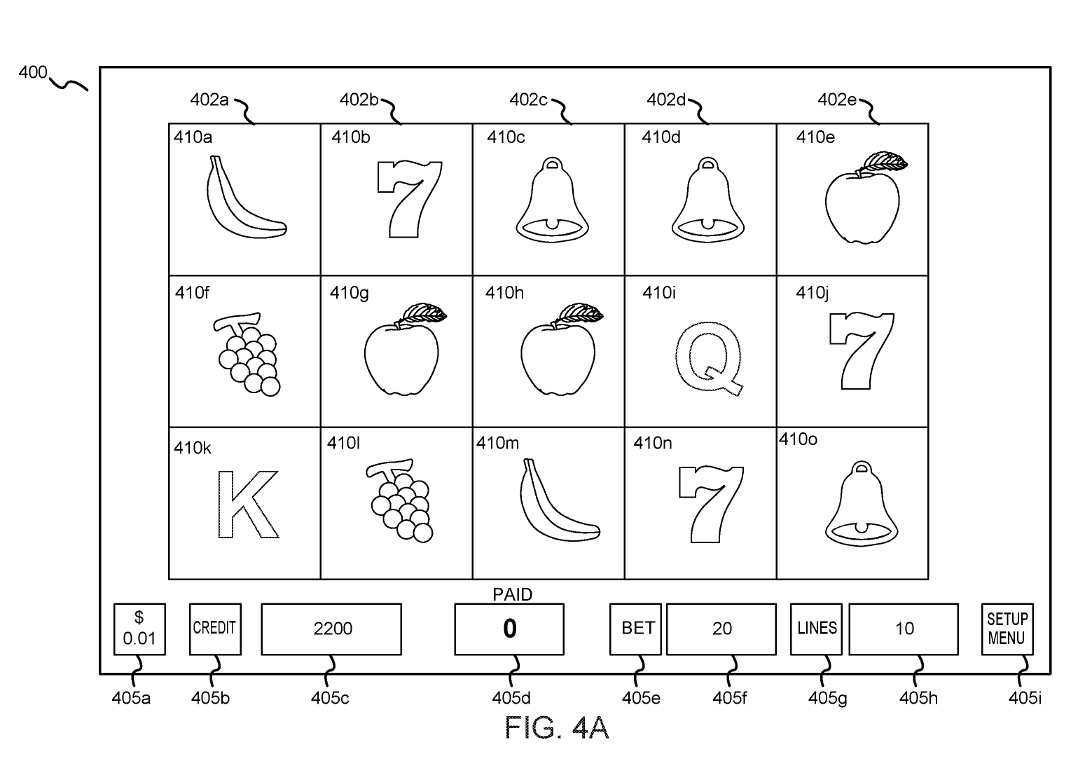

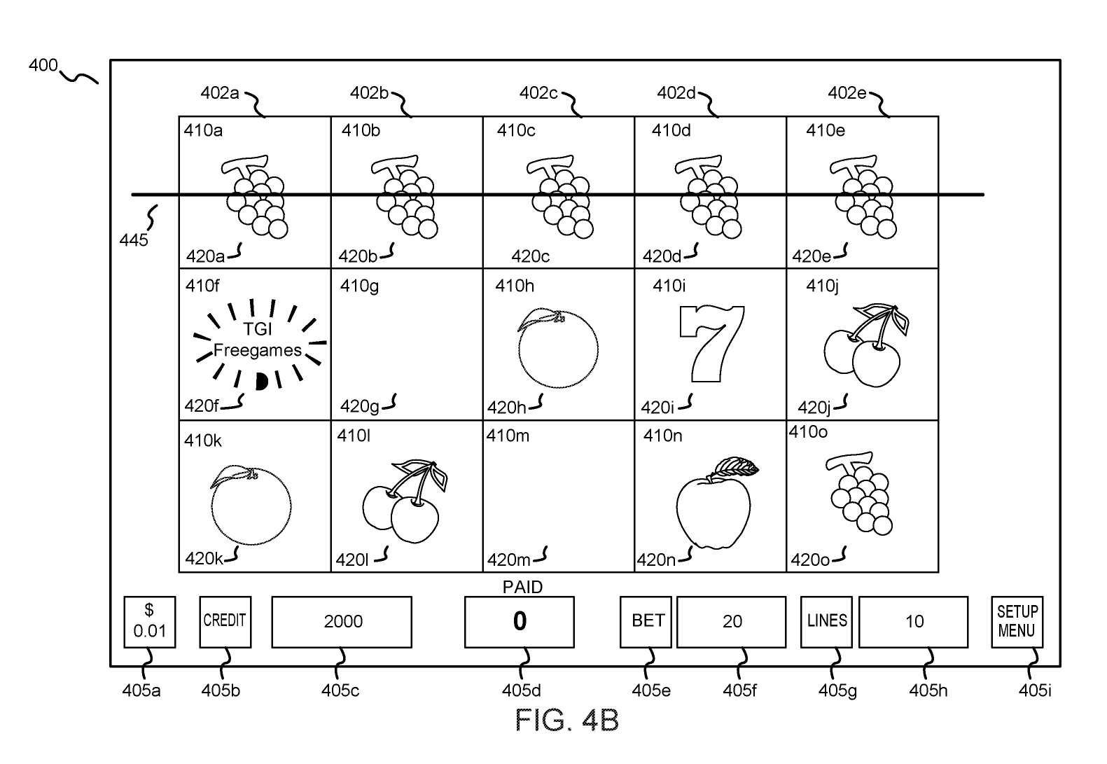

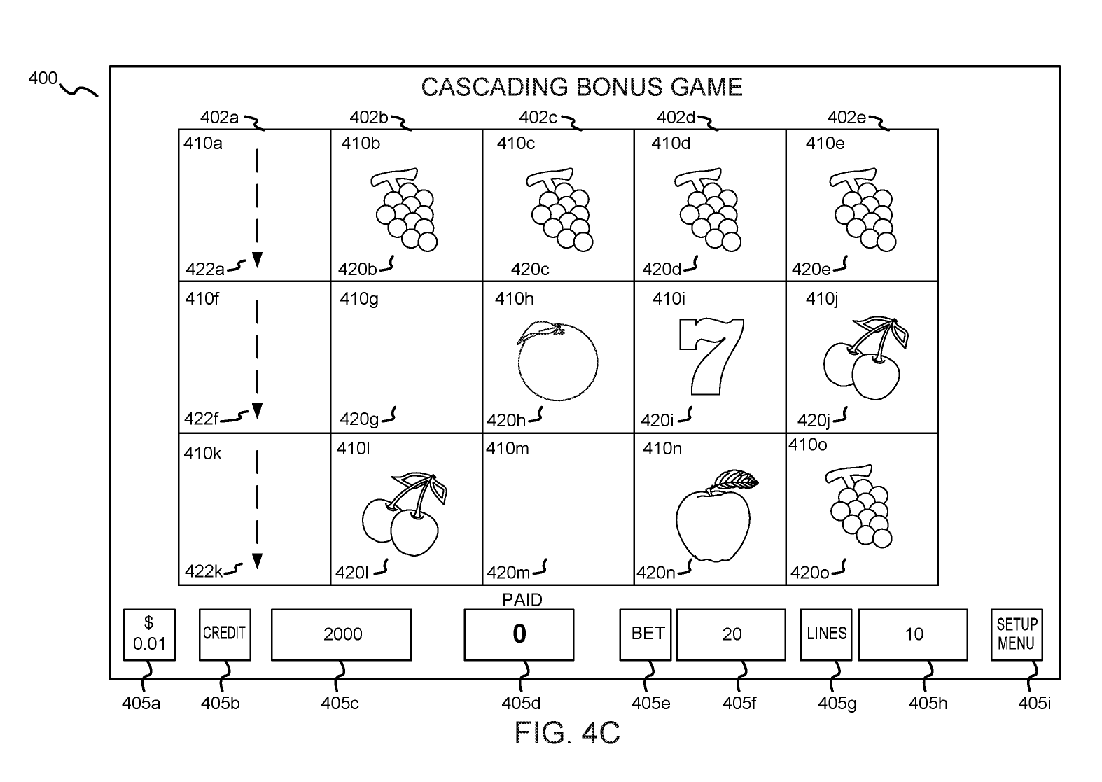

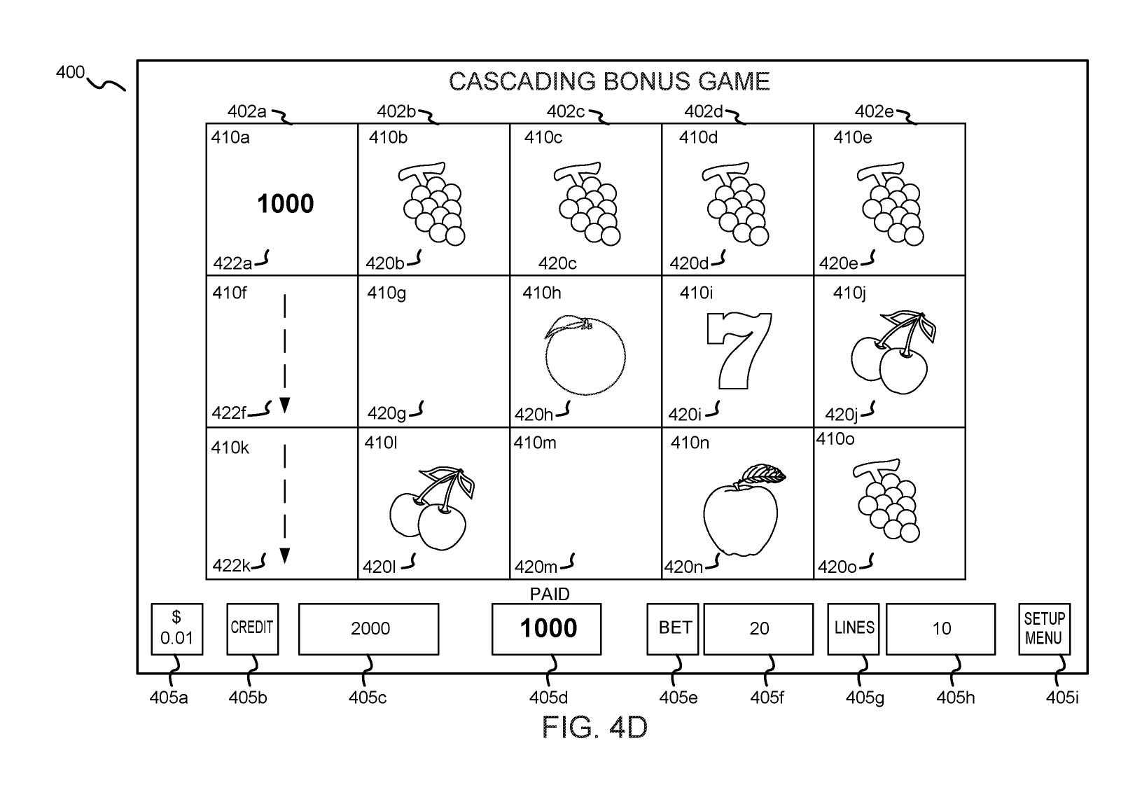

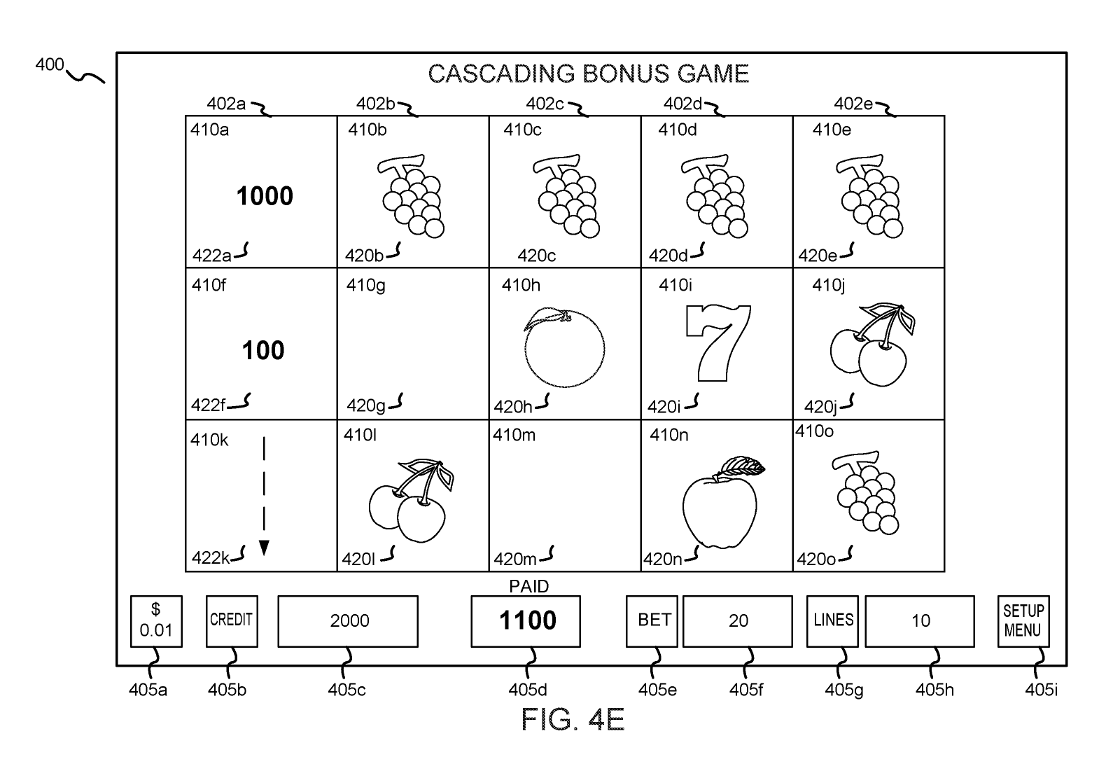

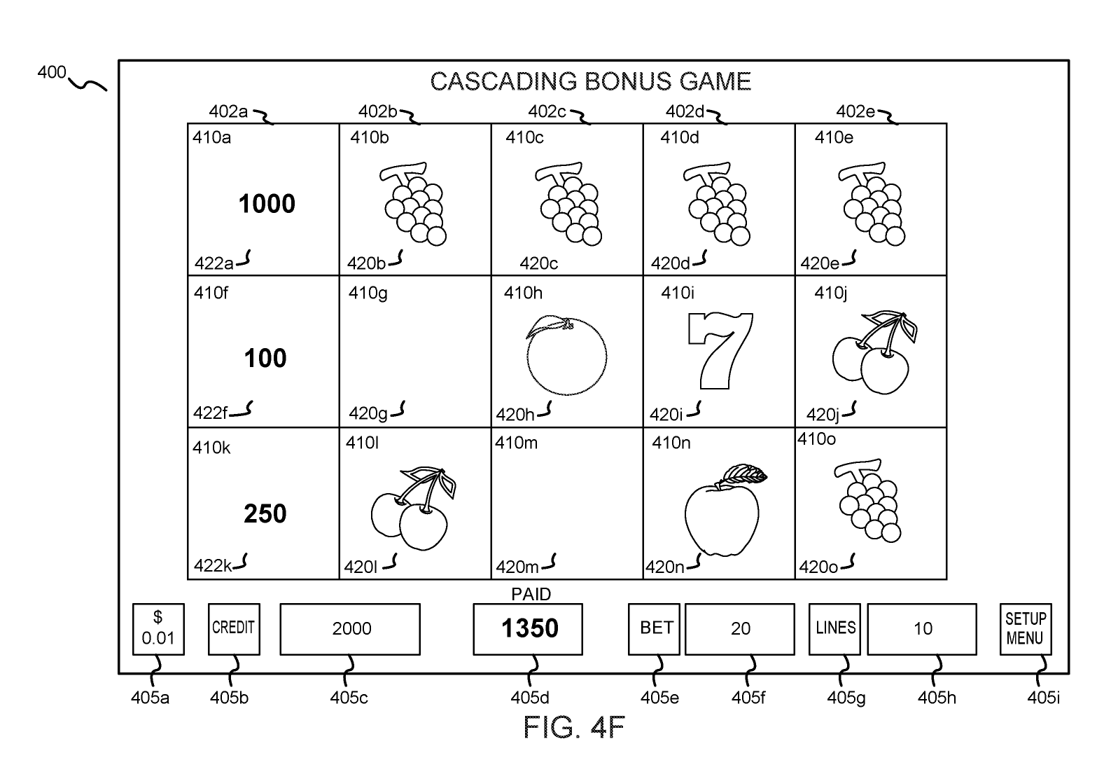

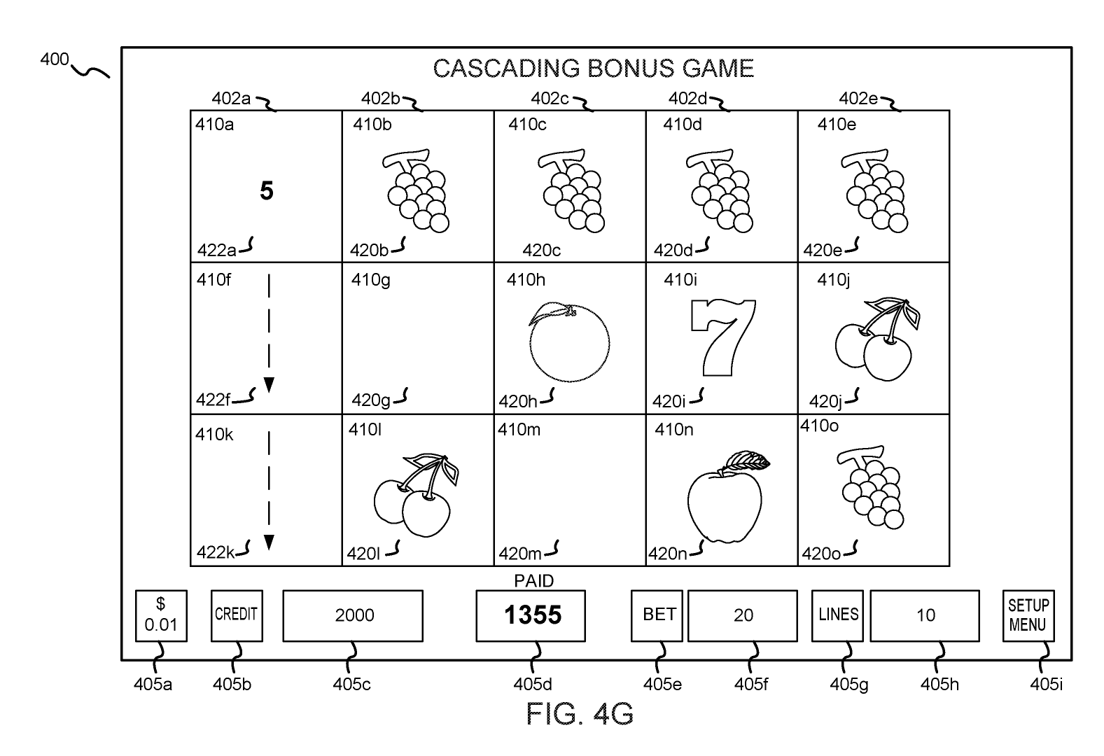

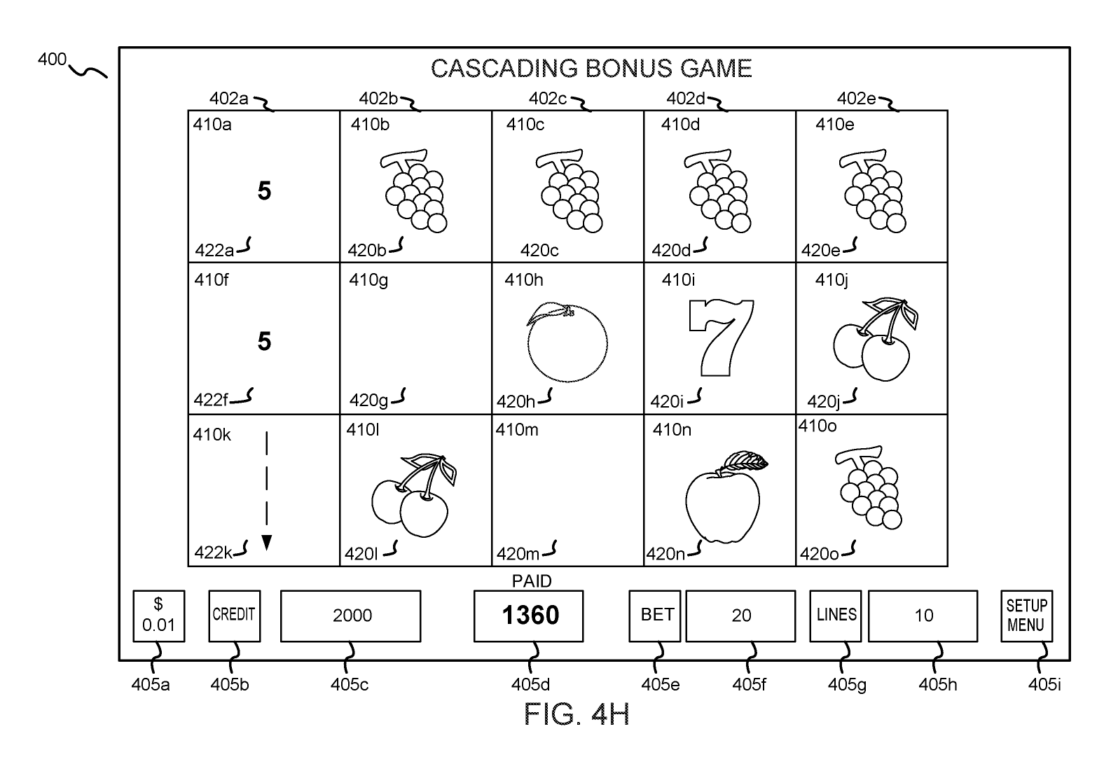

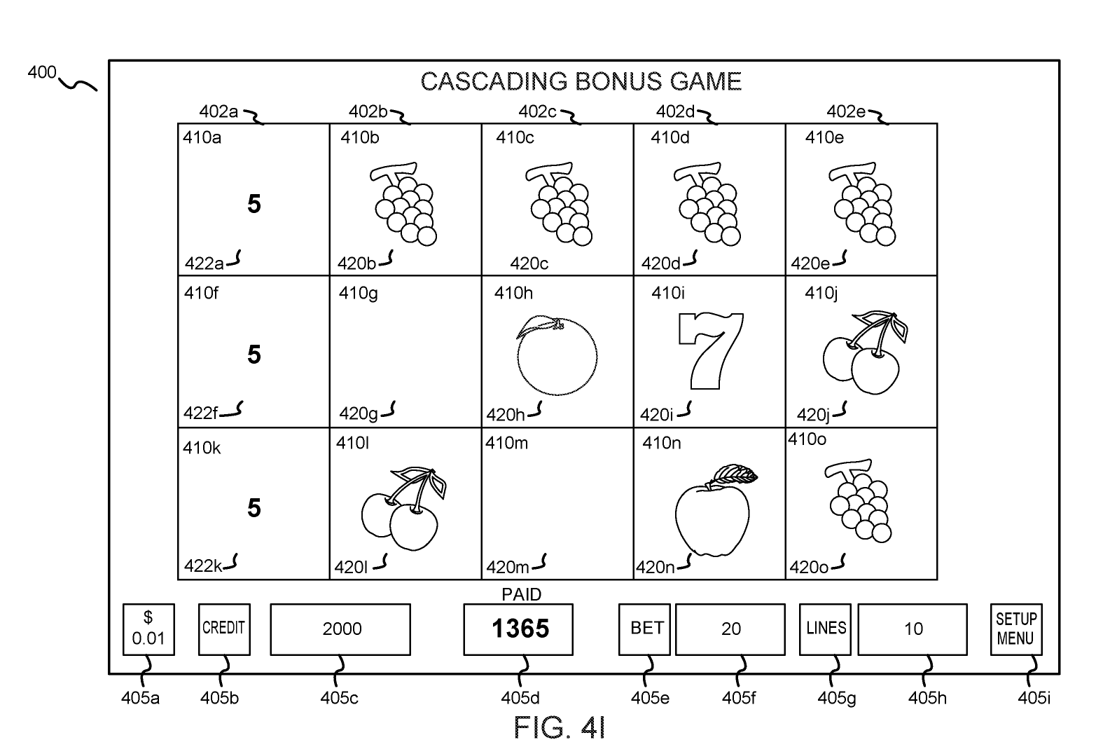

FIGS. 4A-4I illustrate screen shots of one embodiment of a gaming system including a repeating free spin win accumulator where the gaming system generated one bonus game triggering symbol.

FIG. 4A illustrates one embodiment of a game display 400 that the gaming device 100 may display on a display device of the gaming system. In one embodiment, game display 400 may be displayed on first display 122 of gaming device 100 illustrated in FIG. 1. However, any other suitable display may be used. The game display 400 displays a set of a plurality of virtual video slot machine reels 402a, 402b, 402c, 402d, and 402e as illustrated in FIG. 4A for a primary or base game. As also illustrated in FIG. 4A, the reels 402a-402e are displayed substantially side by side. It should be appreciated that reels 402a-402e can be displayed with any suitable amount of separation or no separation. It should be appreciated that the game shown in game display 400 is merely representative and may have more or fewer game elements shown in the game display 400. It should also be appreciated that other games may be used for the primary or base game.

The plurality of reels 402a-402e are each associated with a set of symbols, where the set of symbols includes a plurality of symbols. Each reel 402a-402e is associated with a plurality of symbols of the set of symbols. Each reel 402a-402e can also be associated with the same or a different plurality of symbol combinations from the first set of symbols. The set of symbols may include numbers, letters, geometric figures, symbols, images, character, blank symbols (e.g., the absence of symbols), animations, or any other suitable graphical depiction. The symbols in the set of symbols may include pay symbols and special or designated symbols. In one embodiment, the at least one predetermined symbol is a triggering symbol for a bonus game. In one embodiment, at least one predetermined symbol must be generated on the reels to trigger the bonus game. In some embodiments, when the gaming system generates more than one predetermined trigging symbol, the gaming system activates more features in the bonus game than when the gaming system generates one predetermined trigging symbol. In one embodiment, the predetermined triggering symbol may be any one of the symbols in the set of symbols. The predetermined triggering symbol may be associated with only one function, but may alternatively be associated with a plurality of different game functions.

Returning now to FIG. 4A, the game display 400 depicts a plurality of symbol display areas 410a, 410b, 410c, 410d, 410e, 410f, 410g, 410h, 410i, 410j, 410k, 410l, 410m, 410n, and 410o. This plurality of symbol display areas can be associated in a manner that provides the appearance of game reels. It should also be appreciated that the symbol display areas may not be associated with game reels in some embodiments. As illustrated in FIG. 4A, symbol display areas 410a, 410b, 410c, 410d, 410e, 410f, 410g, 410h, 410i, 410j, 410k, 410l, 410m, 410n, 410o are associated in a manner that provides the appearance of a set of five slot machine game reels. In one embodiment, the plurality of symbol display areas that provide the appearance of five game reels may be arranged in a manner that visibly shows three symbol positions of each of the five game reels. For example, the symbol display areas 410a-4010 are each associated with positions on reels 402a-402e, respectively. As shown in FIG. 4A, symbol display areas 410a, 410f, and 410k are associated with reel 402a; symbol display areas 410b, 410g, and 410l are associated with reel 402b; symbol display areas 410c, 410h, and 410m are associated with reel 402c; and symbol display areas 410d, 410i, and 410n are associated with reel 402d; and symbol display areas 410e, 410j, and 420o are associated with reel 402e. The arrangement illustrated in the embodiment of FIG. 4A thus creates a visible display area of the reels 402a-402e comprising three visible symbol positions for each reel. When viewed together, reels 402a-402e appear like a 3-row by 5-column reel array in display 400. In other embodiments, smaller or larger visible areas of the reels can be displayed. That is, the reels 402a-402e may show fewer or a larger number of visible symbol display areas. While symbol display areas are illustrated with defined boxes, it should be appreciated that in some embodiments, the defined boxes are not visible to the player. It should also be appreciated that in some embodiments, the symbol display areas are other shapes or not defined shapes.

Each reel 402a-402e may display a plurality of symbols that the gaming system generates from the sets of symbols in their respective symbol display areas as illustrated in FIG. 4A. In one embodiment, the reels may be shown spinning in one direction to simulate slot machine reels. However, it should be appreciated that the reels may be shown spinning in any suitable direction. The reels may also be shown spinning in different directions in some embodiments.

Game display 400 also includes several information areas and buttons 405a-405i. These information areas and buttons 405a-405i are illustrated in a particular arrangement, but may be arranged in any suitable manner in different embodiments. In some embodiments, game display 400 may include more or fewer display areas and buttons 405a-405i than illustrated in FIG. 4A-4H. Information area 405a illustrates an example value of one credit for the game displayed in game display 400. Information areas 405b and 405c illustrate an example of the amount of the player's available credits. Information area 405d illustrates the amount of credits a player has won. Because FIG. 4A illustrates the start of a play of a game, the information area 405d shows zero credits have been won. Button 405e illustrates a software button that the player can select to place a bet or wager. It should be appreciated that the functionality of button 405e may also be replicated or replaced with a hardware button on the gaming device 100. Information area 405f illustrates that the player has selected to wager 20 credits. Button 405g illustrates a software button that the player can select to determine how many pay lines to wager on. It should be appreciated that the functionality of button 405g may also be replicated or replaced with a hardware button on the gaming device 100. Information area 405h illustrates that the player selected to wager on 10 pay lines. Button 405i illustrates a software button that the player can select to obtain information about the game, change certain aspects of the game, obtain help, place an order, etc.

To start a gaming session, a player provides the gaming system with a deposit of value, using one of the suitable mechanisms discussed above. The gaming system receives and validates the player's deposit of value. The gaming system can then issue credits (or gaming credits) to the player based on the received value. The credits enable the player to initiate a play of a game and to also place wagers on a play of the game. The gaming system may provide a visual indication of the player's credit balance to the player as discussed above in information area 405c.

To initiate a play of a game, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. The player may also actuate a game start button, a spin button, or a lever. The gaming system may deduct the appropriate credits from the player's credit balance after the wager or at any suitable time.

Upon receipt of the player's wager and activation of the game start button, the gaming system may show a display of spinning reels for each of the reels 402a-402e. The spinning may appear to occur in a vertical top to bottom direction or in a vertical bottom to top direction (not shown), or in a combination of vertical directions (not shown). In one embodiment, the gaming system randomly generates symbols from the set of symbols for reels 402a-402e, respectively. As noted above, the gaming system may rely on random generation performed by a pseudo RNG, a true RNG, or hardware RNG specifically designed for gaming systems. In one embodiment, the gaming system may also update the player's credit meter (information area 405c) to reflect the player's available credit balance. As shown in FIG. 4B, the player's credit meter (information area 405c) was decremented by 20 credits from 2200 to 2000 to reflect the 20 credit wager the player placed for the play of the game.

The gaming system displays the generated symbols 420a-420o in symbol display areas 410a-410o as illustrated in FIG. 4B. Symbols 420a-420o displayed on reels 402a-402e illustrate the randomly generated symbols from the set of symbols after the reels have stopped spinning. As illustrated in FIG. 4B, the gaming system randomly generated and displayed symbols 420a, 420f, and 420k in symbol display areas 410a, 410f, and 410k for reel 402a. The gaming system also randomly generated and displayed symbols 420b, 420g, and 420l in symbol display areas 410b, 410g, and 410l for reel 402b; symbols 420c, 420h, and 420m in symbol display areas 410c, 410h, and 410m for reel 402c; symbols 420d, 420i, and 420n in symbol display area 410d, 410i, and 410n for reel 402d; symbols 420e, 420j, and 420o in symbol display area 410e, 410j, and 410o for reel 402e.

As illustrated in FIG. 4B, the gaming system generated and displayed Grape symbols (420a, 420b, 420c, 420d, 420e, 420o), a TGI Freegames symbol (420f), blank symbols (420g. 420m), a Seven symbol (420i), Cherry symbols (420j, 420l), Orange symbols (420h, 420k), and an Apple symbol (420n) in the game display 400. It should be appreciated that the displayed symbol combinations are merely for explanatory purposes and the gaming system may randomly generate any suitable combination of symbols based on defined symbol sets.

FIG. 4B further illustrates one embodiment of a gaming system executing an evaluation of the generated symbols on reels 402a-402e for winning symbol combinations. As noted above, the player may have wagered on one or more pay lines (such as 10 pay lines shown in information area 405h). In one embodiment, at least the active (wagered on pay lines) are evaluated for winning symbol combinations. Any suitable number of pay lines may be used to evaluate winning symbol combinations.

In the embodiment illustrated in FIG. 4B, the gaming system evaluated the generated symbol combinations for winning symbol combinations. In FIG. 4B, the gaming system determined that a winning symbol combination is displayed across one wagered pay line. The pay line spans across a horizontal direction of symbol display areas including symbol display areas 410a, 410b, 410c, 410d, and 410e. In this embodiment, the gaming system displayed five Grape symbols along a horizontal pay line on which the player had placed a wager. The gaming system determined the five Grape symbols form a winning symbol combination based on a pay table associated with the gaming system. The winning pay line is illustrated as pay line 445 in FIG. 4C across the winning row of reels 402a-402e.

As noted at block 362 of FIG. 3B, in one embodiment, the gaming system may also evaluate the generated symbols on reels 402a-402e for bonus triggering symbols. In FIG. 4B, the gaming system determined that a TGI Freegames symbol (420f) was generated for the play of the game. In the illustrated embodiment, the TGI Freegames symbol was designated as the bonus game triggering symbol. It should be appreciated that any other suitable symbol could be designed as the bonus game triggering symbol. As also illustrated in FIG. 4B, the gaming system highlighted the TGI Freegames symbol so that player understands that the player won a bonus game or other game features. It should be appreciated that the gaming system may highlight the bonus triggering symbol in any suitable manner. It should also be appreciated that the gaming system may not highlight the bonus triggering symbols in some embodiments.

In some embodiments, the gaming system may be required to generate more than one bonus triggering symbol to activate a bonus game. In other embodiments, the features available in the bonus game may depend on the quantity of bonus triggering symbols that the game system generates. For example, as will be shown in FIG. 4C, because one bonus triggering symbol was generated, the gaming system unlocked one reel for the bonus game. In other embodiments, one bonus triggering symbol may trigger the bonus game and unlock two or more reels (or alternatively, a predetermined quantity of symbol display areas—like six or seven symbol display areas). In one embodiment, at least one bonus trigging symbol must be generated in the far most reel 402a (in any symbol display area) to trigger the bonus game. That is, if the at least one bonus triggering symbol is generated in reels 402b, 402c, 402d, or 402e, the gaming system may not activate the bonus game. However, in other embodiments, the bonus triggering symbol may appear on any reel in any symbol display area to trigger the bonus game. In some embodiments, the gaming system may evaluate the bonus triggering symbols from a right to left direction along the reels (rather than left to right along the reels).

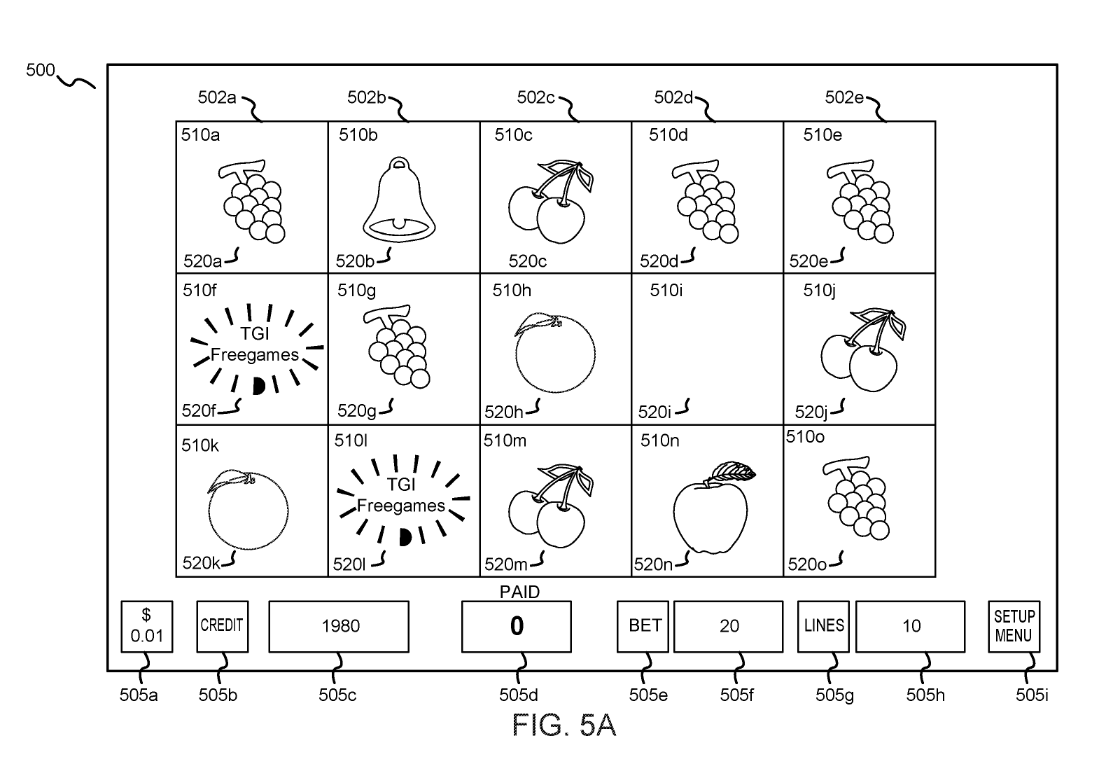

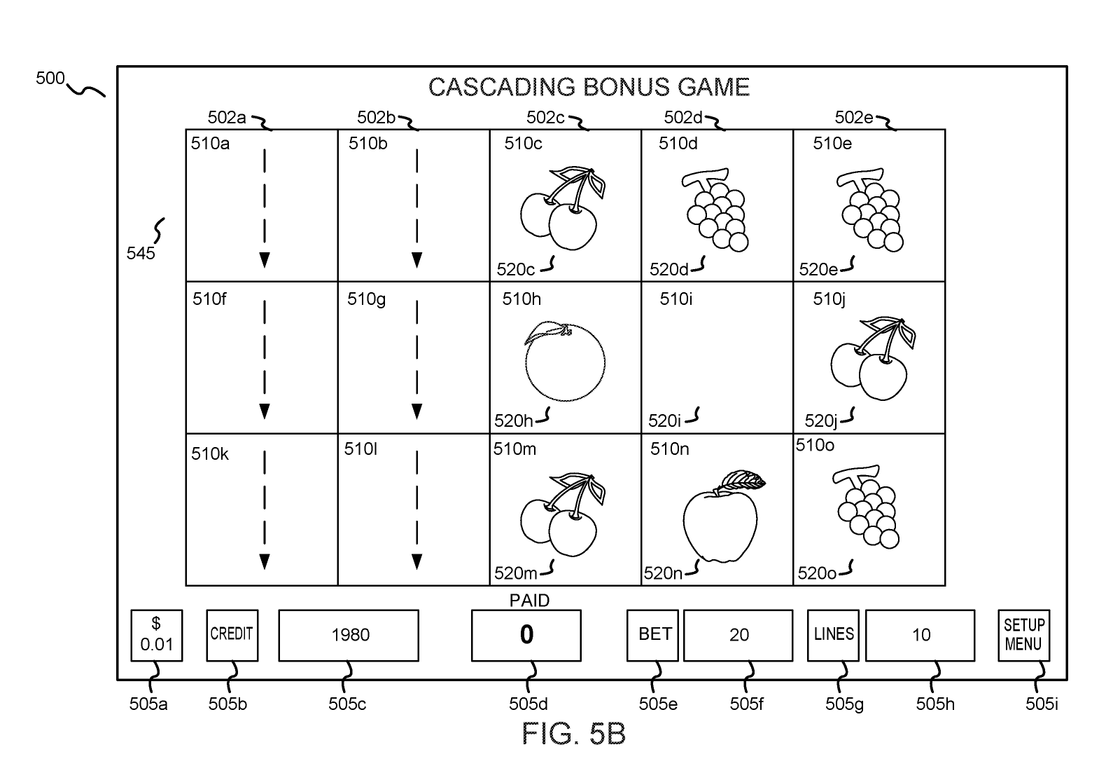

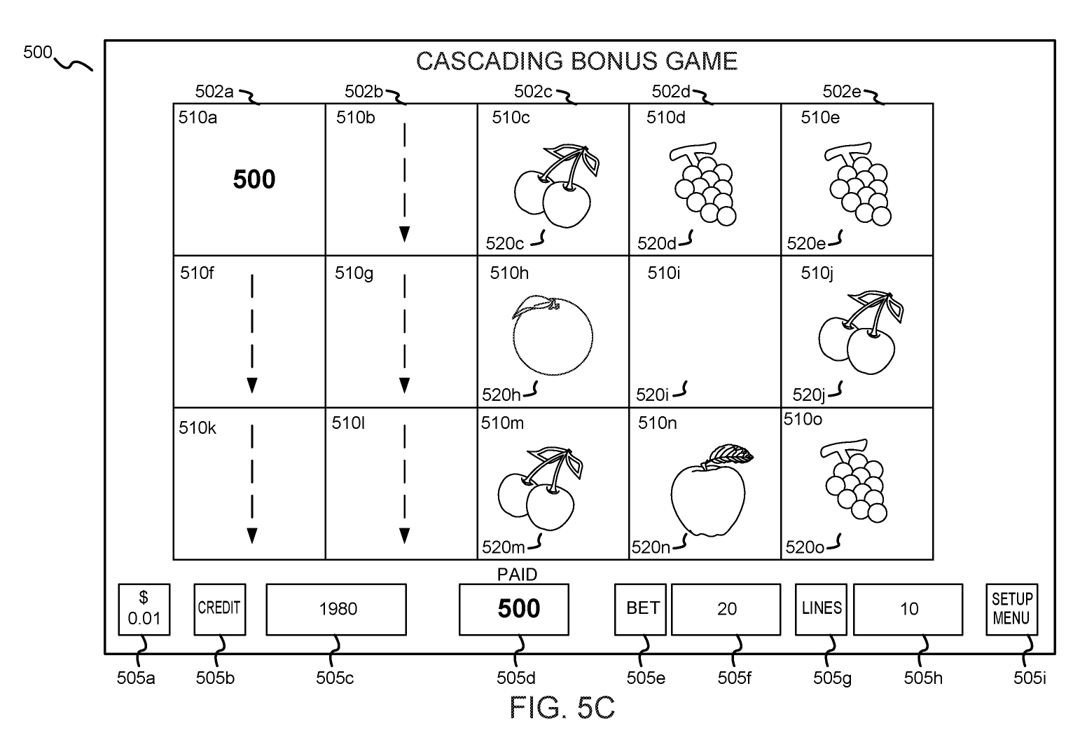

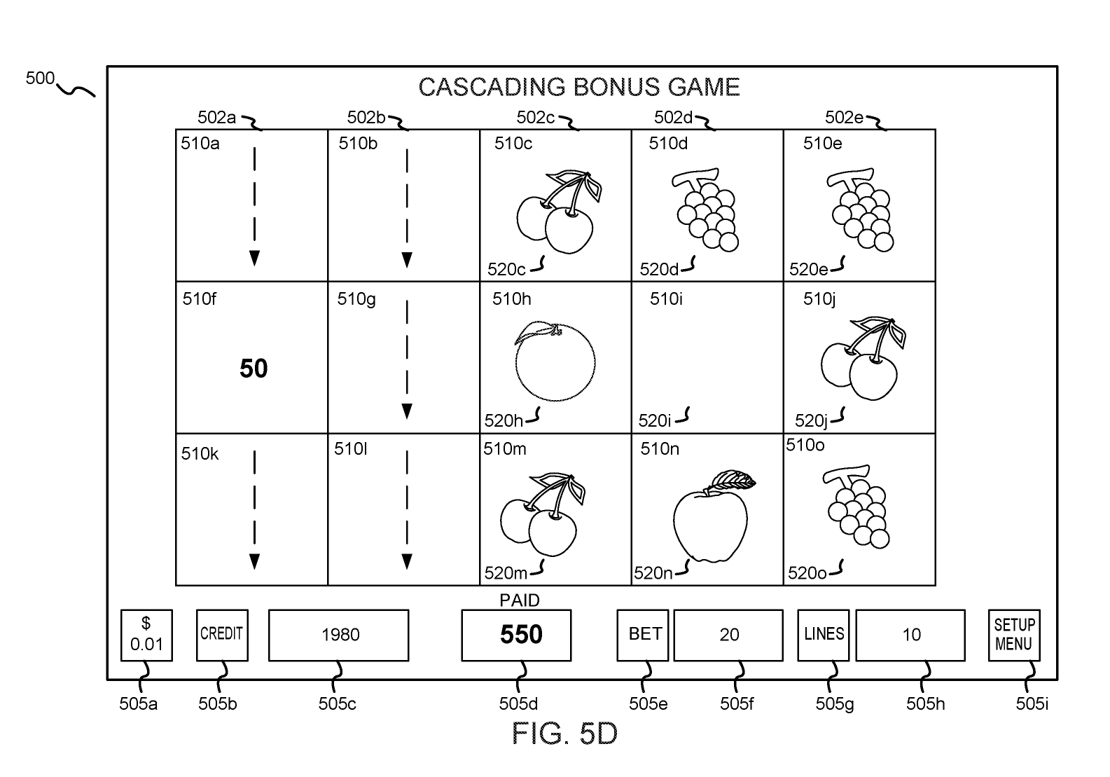

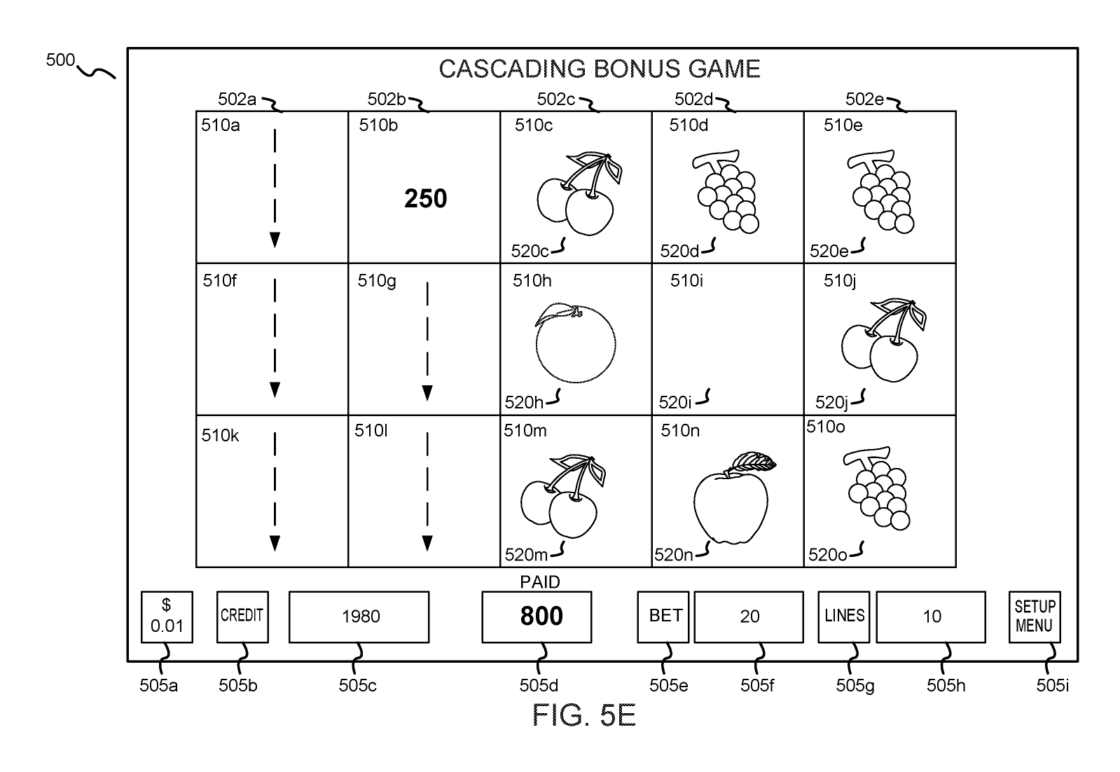

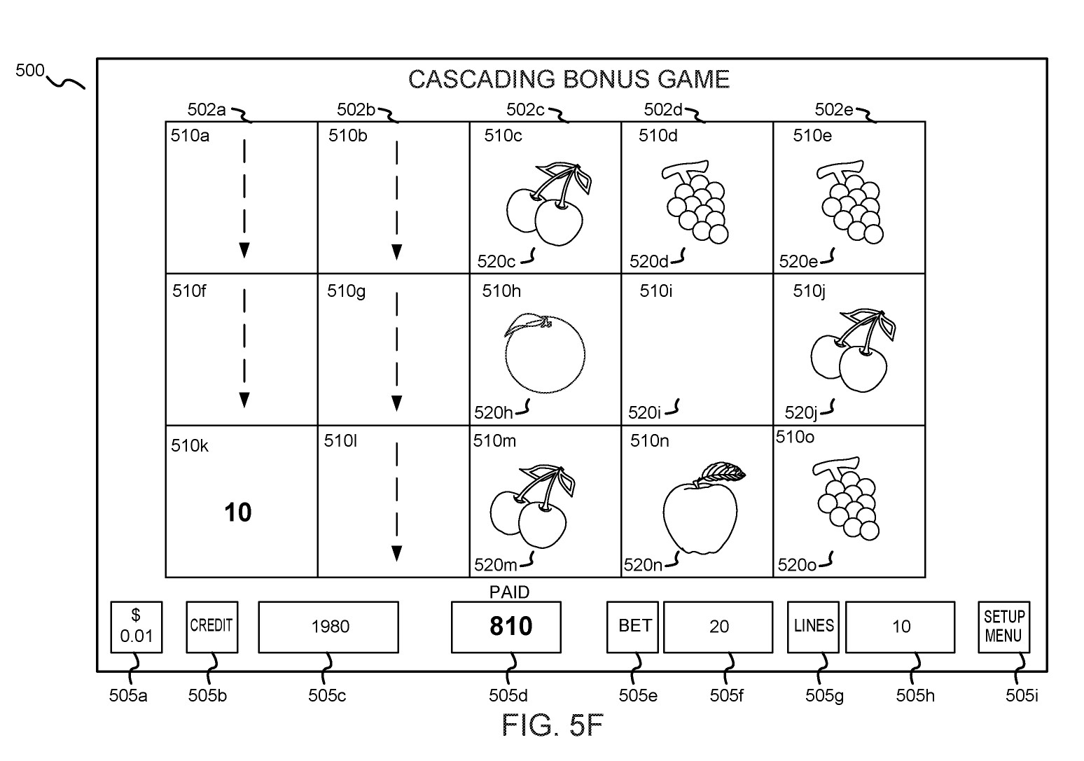

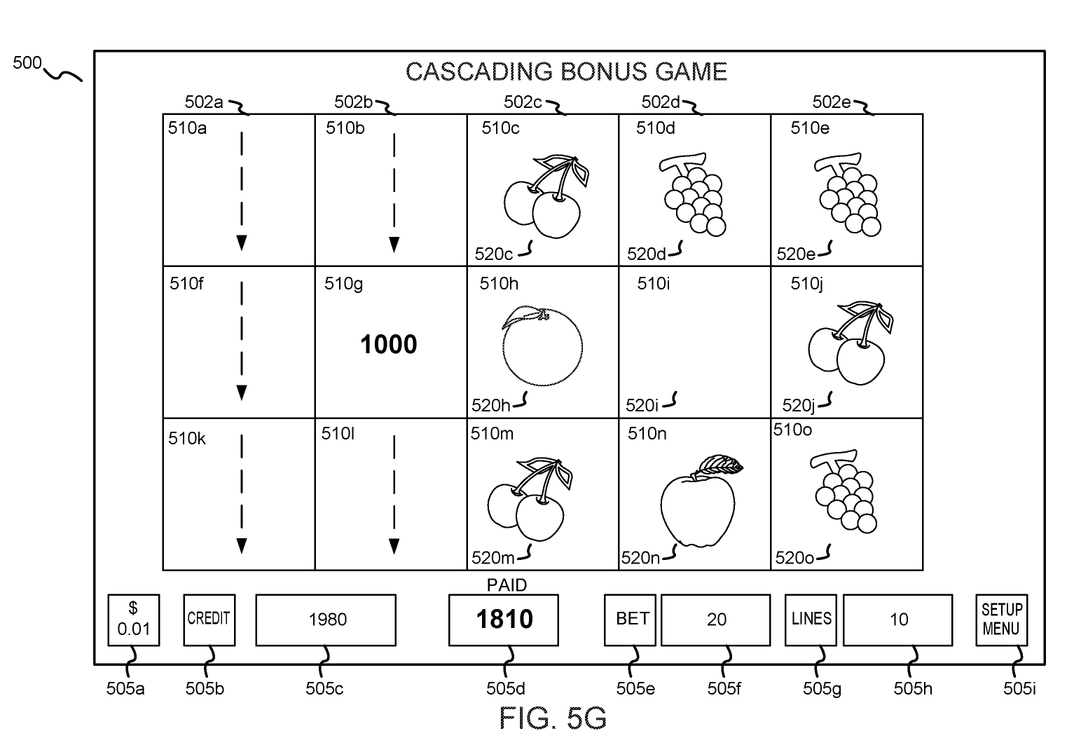

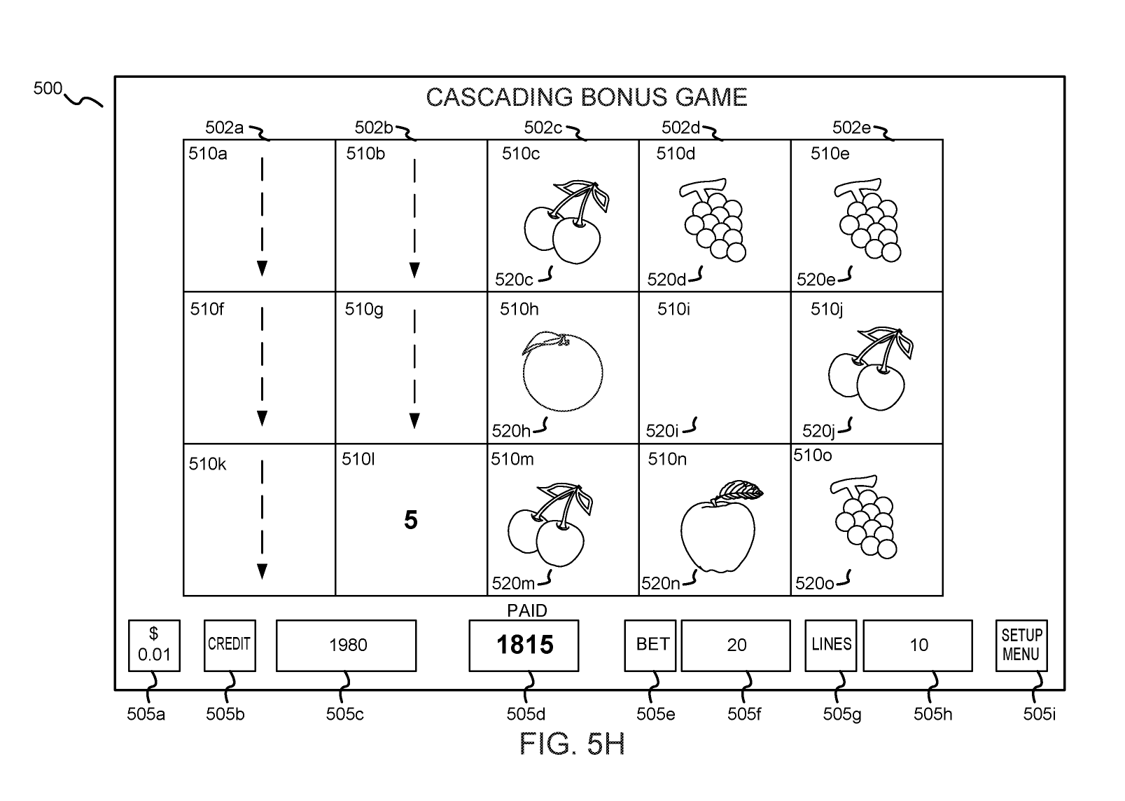

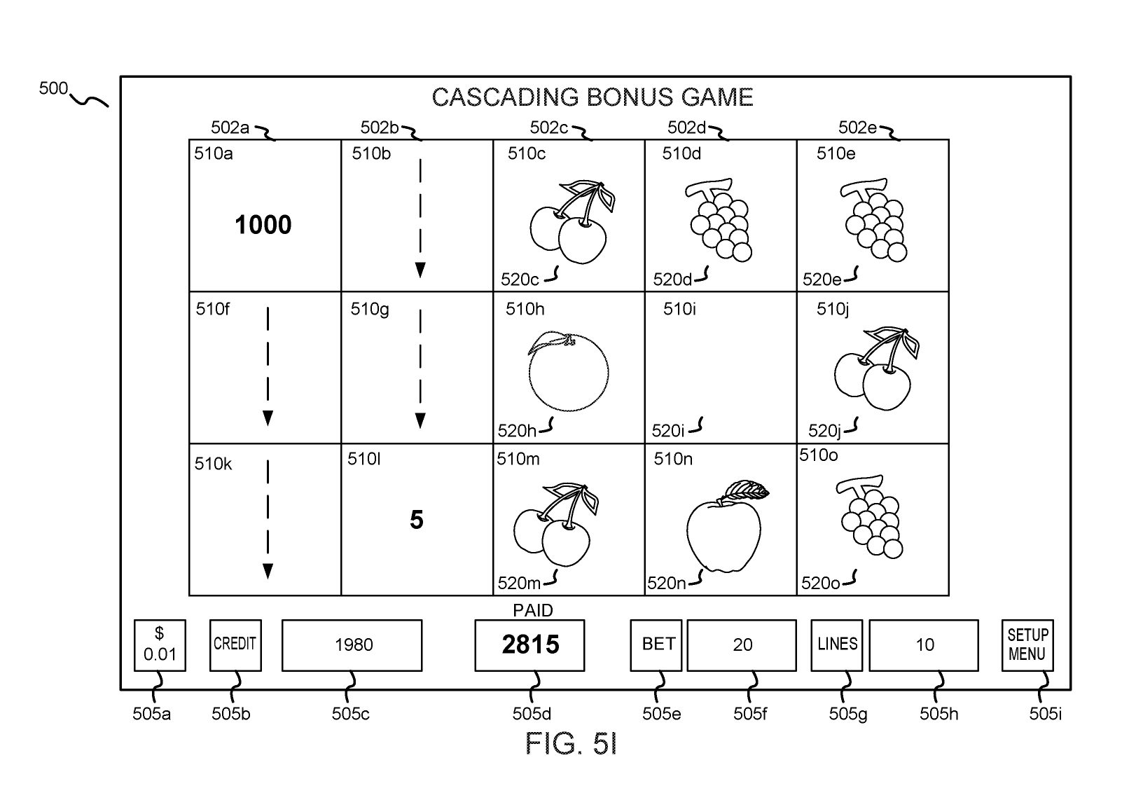

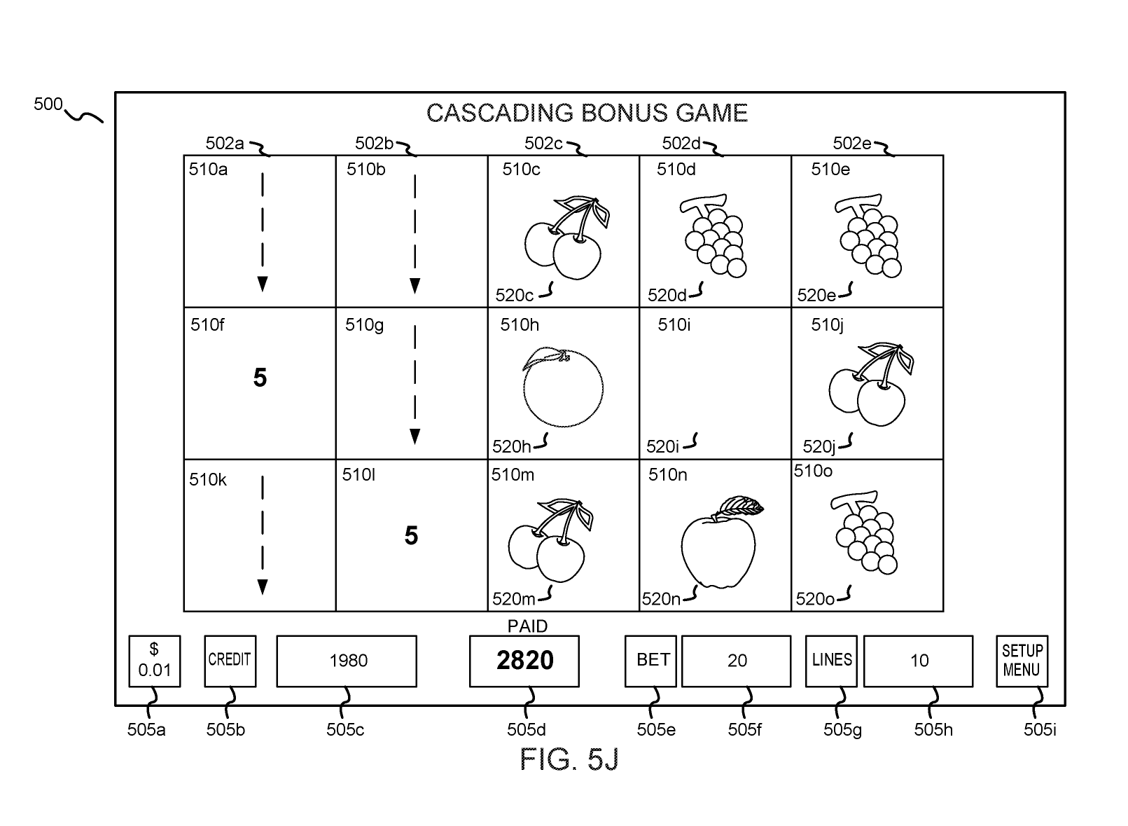

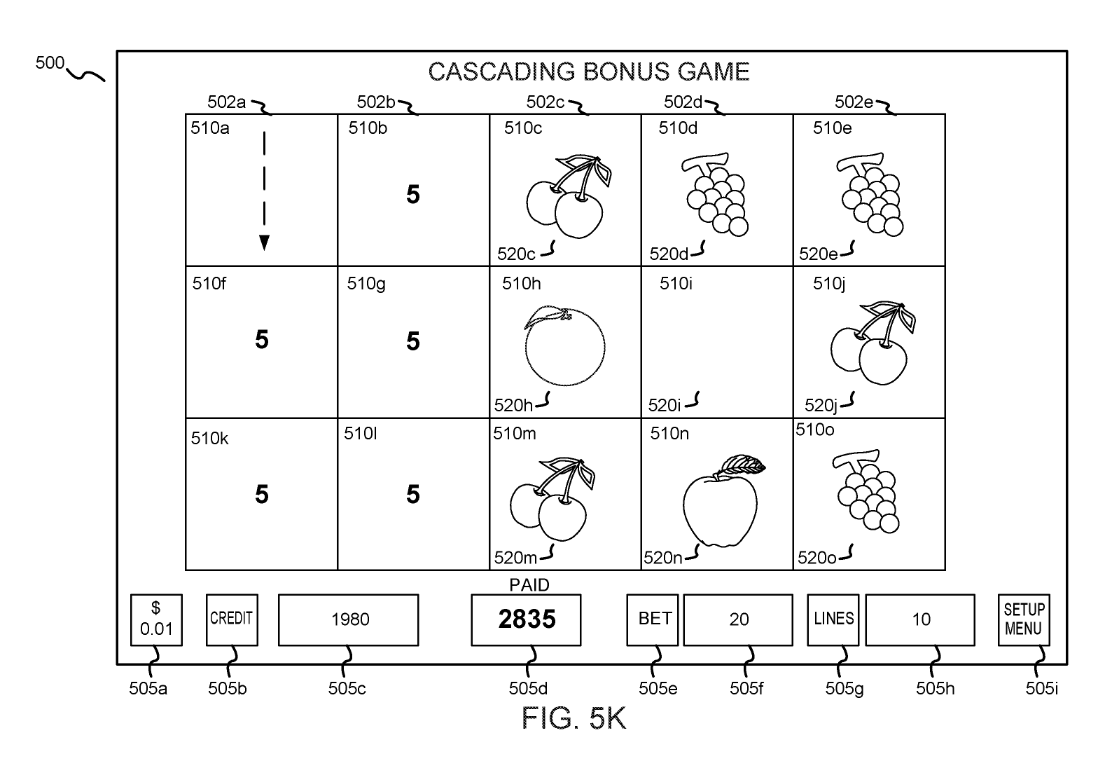

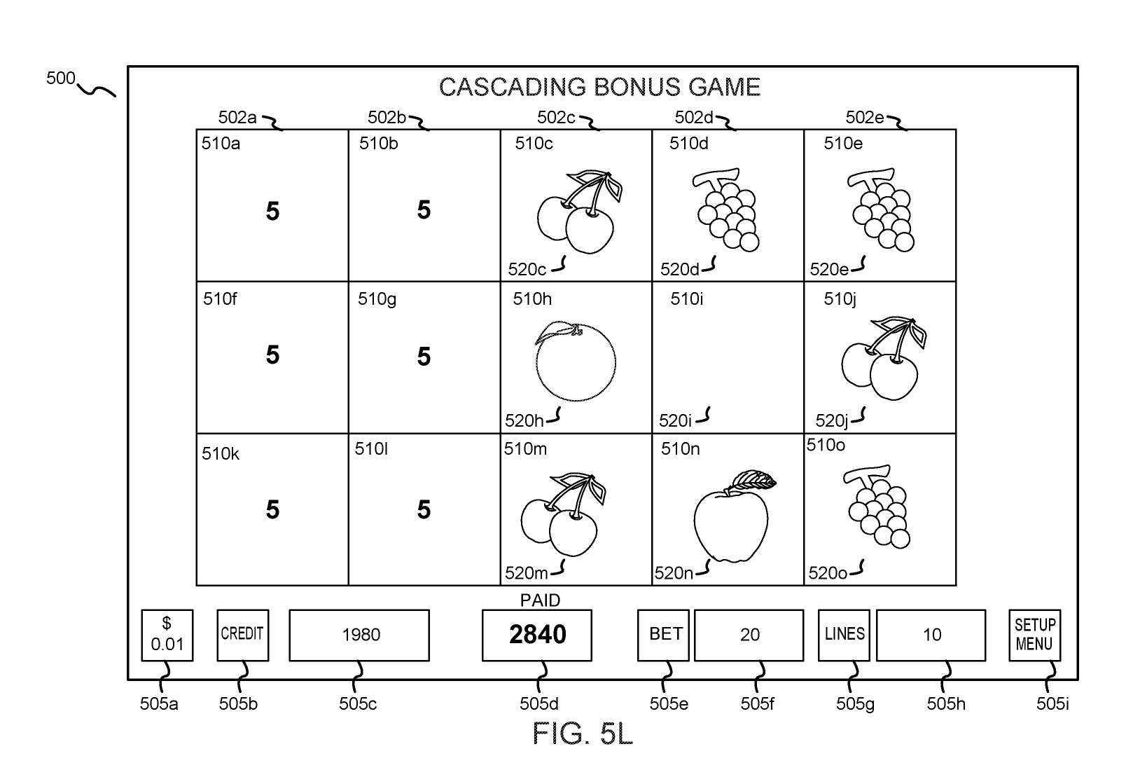

In one embodiment, for more reels or more symbol display areas to become unlocked in the bonus game, the bonus triggering symbol must appear in adjacent reels starting from the far left reel. For example, as will be discussed in connection with FIG. 5A, a gaming system generated two bonus triggering symbols in adjacent reels 502a and 502b when evaluated from the left most reel. In some embodiments, unlocking additional reels requires the gaming system to generate at least one more bonus triggering symbol on reel 502c. Unlocking yet more reels like reel 502d and 502e may require the gaming system to generate bonus triggering symbols on reels 502d and 502e. However, in some embodiments, the gaming system is not required to generate bonus triggering symbols on adjacent reels. That is, in some embodiments, the gaming system may generate a bonus trigging symbol on reel 502b and 502e and still trigger the bonus game. In some embodiments, the bonus triggering symbols activates the bonus game like a scatter symbol. In some embodiments, the bonus triggering symbol activates the bonus game when evaluated along an active pay line. In other embodiments, the gaming system does not require the bonus triggering symbols to appear on an active pay line to trigger the bonus game.

Returning now to FIG. 4C, the gaming system determined that one bonus triggering symbol (the TGI Freegames symbol 420f) was generated on reel 402a in symbol position 410f. Based on the generated bonus triggering symbol on reel 402a, the gaming system activated a bonus game and unlocked one reel 402a for the bonus game. In alternative embodiments, other reels can be unlocked for the bonus game. Reels 402b, 402c, 402d, and 402e remain locked for the bonus game, which means the gaming system will not generate symbols in the bonus game for these reels and associated symbol display areas. In some embodiments, the gaming system keeps the symbols previously generated in the primary game displayed for the bonus game. In alternative embodiments, the gaming system may remove the symbols so that the previously generated symbols from the primary game are not displayed in the bonus game.

In one embodiment, the gaming system associates a different set of symbols with each of the unlocked symbols display areas 410a, 410f, and 410k. Thus, the gaming system generates, using the RNG discussed above, symbols for each of symbol display areas 410a, 410f, and 410k from a different set of symbols in one embodiment. Each of these different sets of symbols may include the same symbols associated with the same or different probabilities of being generated. In other embodiments, these different sets of symbols may include different symbols. As previously noted, these sets of symbols may be the same as symbols from the base game or different from the base game. In one embodiment, as will be illustrated in FIG. 4D-4I and FIG. 8, the set of symbols may comprise numbers or values. Each symbol or number may be associated with a probability of being generated in a game. In some embodiments, the probability of a symbol or number being generated in a game may change based on the player's wager. For example, if the player placed a minimum wager, the gaming system may increase the probability that lower value symbols will be generated in the bonus game (or increase the quantity of lower values symbols in the set of symbols). Alternatively, if the player placed a wager higher than the minimum wager, the gaming system may increase the probability or weight that a higher value symbol will be generated in the bonus game (or increase the quantity of higher value symbols in the set of symbols). Likewise, if the player placed the maximum wager in a game in one embodiment, the gaming system may assign a higher probably that a 1000 credit symbol will be generated during the bonus game than if the player placed a minimum wager (or include more 1000 credit symbols in the symbol set).

In some embodiments, each reel is associated with one set of symbols such that the gaming system generates symbols for each symbol display area on a reel from the same set of symbols. For ease of discussion, a set of symbols used for the bonus game shall be referred to as the bonus symbol set.

Returning to FIG. 4C, the gaming system entered the bonus game and activated each of the unlocked symbol display areas 410a, 410f, and 410k. FIG. 4C illustrates the gaming system cycling or spinning symbols in each of the symbol display areas 410a, 410f, and 410k. In some embodiments, the spinning symbols may appear like an individual reel spinning in each unlocked symbol display area. In this embodiment, the directional arrows indicate the direction of the cycling or spinning symbols. However, any suitable direction may be used. In some embodiments, each symbol display area spins or cycles through symbols in different directions. The gaming system may the generate symbols from each of the bonus symbol sets for each of the symbol display areas. In another embodiment, the gaming system generates a symbol from a bonus symbol set as the gaming device is ready to display the generated symbol in a particular symbol display area.

In FIG. 4D the gaming system generated and displayed, from the bonus symbol set associated with symbol display area 410a, the 1000 symbol 422a. In this embodiment, the 1000 symbol 422a is also associated with a value of 1000 credits. As shown in the information display area 405d, the gaming system updated the player's win meter to reflect the 1000 credit win.

In FIG. 4E, the gaming system generated and displayed, from the bonus symbol set associated with symbol display area 410f, the 100 symbol 422f. In this embodiment, the 100 symbol 422f is also associated with a value of 100 credits. As shown in the information display area 405d, the gaming system updated the player's win meter to reflect the 100 credit win (e.g., 1000 from symbol display area 410a+100 from symbol display area 410f). As also illustrated in FIG. 4E, the gaming system continued to display the 1000 symbol 422a, while generating and displaying the 100 symbol 422f In an alternative embodiment, the gaming system may conceal prior generated symbols as the gaming system moves to the next unlocked symbol display area. In some such embodiments, the gaming system will show cycling or spinning symbols in each of the unlocked symbol display areas that are not revealing a generated symbol.

In FIG. 4F, the gaming system generated and displayed, from the bonus symbol set associated with symbol display area 410k, the 250 symbol 422k. In this embodiment, the 250 symbol 422k is also associated with a value of 250 credits. As shown in the information display area 405d, the gaming system updated the player's win meter to reflect the new 250 credit win (e.g., rising to 1350 credits won in the bonus game). As also illustrated in FIG. 4F, the gaming system continued to display the 1000 symbol 422a and the 100 symbol 422f while generating and displaying the 100 symbol 422f It should be appreciated that in the illustrated embodiment, the unlocked symbols were displayed sequentially and in a cascading format.

In one embodiment, the gaming system may evaluate all of the generated and displayed awards before, during, or after the awards are displayed to update the player's win meter. The gaming system may also evaluate each of the generated symbols to determine if any of the symbols will cause an associated symbol display area to become locked. In this embodiment, the lock symbol is the lowest value symbol in the bonus set of symbols. As illustrated in FIG. 8, the 5 symbol is set as the lock symbol 810. However, in the illustration of FIG. 4F, the gaming system evaluates the symbols and determines that no lock symbol was generated for an unlocked symbol display area. As such, the gaming system may continue the play of the game and generate at least one more symbol from the associated bonus symbol set for each unlocked symbol display area.

As illustrated in FIG. 4G, the gaming system generated and displayed, from the bonus symbol set associated with symbol display area 410a, the 5 symbol. In this embodiment, the 5 symbol is associated with a value of 5 credits. As shown in the information display area 405d, the gaming system updated the player's win meter to reflect the new 5 credit win (e.g., rising to 1355 credits won in the bonus game). In this embodiment, the 5 symbol is also associated with the lock symbol. Because the gaming system generated a lock symbol in unlocked symbol display area 410a, the gaming system also locked symbol display area 410a for the remainder of the game. In one embodiment, the gaming system does not generate another symbol from the associated bonus symbol set for display area 410a. However, it should be appreciated that in some embodiments, the gaming system may unlock symbol display area 410a if certain triggering events occur.

As illustrated in FIG. 4H, the gaming system moved on to symbol display area 410f. The gaming system generated and displayed, from the bonus symbol set associated with symbol display area 410f, the 5 symbol. In this embodiment, the 5 symbol is associated with a value of 5 credits. As shown in the information display area 405d, the gaming system updated the player's win meter to reflect the new 5 credit win (e.g., rising to 1360 credits won in the bonus game). In this embodiment, the 5 symbol is also associated with the lock symbol. Because the gaming system generated a lock symbol in unlocked symbol display area 410f, the gaming system also locked symbol display area 410f for the remainder of the game. In one embodiment, the gaming system does not generate another symbol from the associated bonus symbol set for display area 410f However, it should be appreciated that in some embodiments, the gaming system may unlock symbol display area 410f if one or more certain triggering events occur. It should also be appreciated that the symbols shown in the figures are for illustration purposes and do not limit the symbols that can be generated in a game. For example, the gaming system may have also generated a nonlocking symbol for symbol display areas 410a and 410f for FIGS. 4G and 4H. Thus, in an alternative embodiment, the symbols display areas 410a and 410f may continue to be unlocked and receive additionally generated symbols from the bonus symbol set for the play of the game.

Returning to FIG. 4I, the gaming system moved on to symbol display area 410k. The gaming system generated and displayed, from the bonus symbol set associated with symbol display area 410k, the 5 symbol. In this embodiment, the 5 symbol is associated with a value of 5 credits. As shown in the information display area 405d, the gaming system updated the player's win meter to reflect the new 5 credit win (e.g., rising to 1365 credits won in the bonus game). In this embodiment, the 5 symbol is also associated with the lock symbol. Because the gaming system generated a lock symbol in unlocked symbol display area 410k, the gaming system locked symbol display area 410k for the remainder of the game.

In the illustrated embodiment, no unlocked symbol display areas remain. Therefore, the gaming system does not generate additional symbols for symbol display areas from the bonus symbol sets. The play of the game ends.

FIGS. 5A-5L illustrate screen shots of one embodiment of a gaming system including a repeating free spin win accumulator where the gaming system generated a plurality of bonus game triggering symbols.

For the sake of brevity, the primary game in FIGS. 5A-5L may operate similar to the primary game discussed in FIG. 4A-4B. In alternative embodiments, the primary game can be a different game. As also noted above, while the repeating free spin win accumulator is depicted as a bonus game, the repeating free spin win accumulator may be applied in a primary game.

Turning to FIG. 5A, the gaming system displays the generated symbols 520a-520o in symbol display areas 510a-510o as illustrated in FIG. 5A. Symbols 520a-520o displayed on reels 502a-502e illustrate the randomly generated symbols from the set of symbols after the reels have stopped spinning. As illustrated in FIG. 5A, the gaming system randomly generated and displayed symbols 520a, 520f, and 520k in symbol display areas 510a, 510f, and 510k for reel 502a. The gaming system also randomly generated and displayed symbols 520b, 520g, and 520l in symbol display areas 510b, 510g, and 510l for reel 502b; symbols 520c, 520h, and 520m in symbol display areas 510c, 510h, and 510m for reel 502c; symbols 520d, 520i, and 520n in symbol display area 510d, 510i, and 510n for reel 502d; symbols 520e, 520j, and 520o in symbol display area 510e, 510j, and 510o for reel 502e.

FIG. 5A further illustrates one embodiment of a gaming system executing an evaluation of the generated symbols on reels 502a-502e for winning symbol combinations. As noted above, the player may have wagered on one or more pay lines (such as 10 pay lines shown in information area 505h). In one embodiment, at least the active (wagered on pay lines) are evaluated for winning symbol combinations. Any suitable number of pay lines may be used to evaluate winning symbol combinations.

In the embodiment illustrated in FIG. 5A, the gaming system evaluated the displayed symbol combinations for winning symbol combinations. In FIG. 5A, the gaming system determined that no winning symbol combinations were displayed across any active pay lines.

As noted at block 362 of FIG. 3B, in one embodiment, the gaming system may also evaluate the generated symbols on reels 502a-502e for bonus triggering symbols. In FIG. 5A, the gaming system determined that two TGI Freegames symbols (520f and 520l) were generated for the play of the game. In the illustrated embodiment, the TGI Freegames symbol was designated as the bonus game triggering symbol. As also illustrated in FIG. 5A, the gaming system highlighted the TGI Freegames symbols so that player understands that the player won a bonus game or other game features. It should be appreciated that the gaming system may highlight the bonus triggering symbol in any suitable manner. It should also be appreciated that the gaming system may not highlight the bonus triggering symbols in some embodiments. As noted in the discussion of FIG. 4A-4I, because two bonus triggering symbols were generated, the gaming system unlocks more reels than were unlocked in FIG. 4A-4I.

Returning now to FIG. 5B, the gaming system determined that two bonus triggering symbols (the TGI Freegames symbol 520f and 520l) were generated on adjacent reels 502a and 502b in symbol positions 510f and 510l, respectively. Based on the generated bonus triggering symbols on reels 502a and 502b, the gaming system activated a bonus game and unlocked two reels 502a and 502b for the bonus game. In alternative embodiments, other reels can be unlocked for the bonus game. For example, reels 502a, 502b, and 502c may be unlocked in some embodiments. As another example, reels 502a, 502b, and 502d may be unlocked.

For illustration purposes in FIG. 5B-5L, reels 502c, 502d, and 502e remain locked for the bonus game, which means the gaming system will not generate symbols in the bonus game for these reels and associated symbol display areas.

In one embodiment, the gaming system associates a different bonus symbol set with each of the unlocked symbols display areas 510a, 510f, 510k, 510b, 510g, and 510l. Thus, the gaming system generates, using the RNG discussed above, symbols for each of symbol display areas 510a, 510f, 510k, 510b, 510g, and 510l from a different set of symbols. It should be appreciated that the compositions of the symbols in the bonus symbol sets and the quantity of bonus symbols sets may vary similar to the variations discussed in connection with FIG. 4A-4I.

Returning to FIG. 5B, the gaming system entered the bonus game and activated each of the unlocked symbol display areas 510a, 510f, 510k, 510b, 510g, and 510l. FIG. 5B illustrates the gaming system cycling or spinning symbols in each of the symbol display areas 510a, 510f, 510k, 510b, 510g, and 510l. The spinning symbols may appear like individual reels in each of symbol display areas 510a, 510f, 510k, 510b, 510g, and 510l. In this embodiment, the directional arrows indicate the direction of the cycling or spinning symbols. However, any suitable direction may be used. In some embodiments, each symbol display area spins or cycles through symbols in different directions. The gaming system may the generate symbols from each of the bonus symbol sets for each of the symbol display areas. In another embodiment, the gaming system generates a symbol from a bonus symbol set as the gaming system is ready to display the generated symbol in a particular symbol display area.

As will be shown in FIG. 5C-5L, the gaming system generates and displays the symbols for the bonus game in a cascading or waterfall format.

In FIG. 5C, the gaming system generated and displayed, from the bonus symbol set associated with symbol display area 510a, the 500 symbol. In this embodiment, the 500 symbol is also associated with a value of 500 credits. As shown in the information display area 505d, the gaming system updated the player's win meter to reflect the 500 credit win.

In FIG. 5D, the gaming system generated and displayed, from the bonus symbol set associated with symbol display area 510f, the 50 symbol. In this embodiment, the 50 symbol is also associated with a value of 50 credits. As shown in the information display area 505d, the gaming system updated the player's win meter to reflect the additional 50 credit win. As also illustrated in FIG. 5D, the gaming system did not continue to display the 500 symbol previously generated for symbols display area 510a, while generating and displaying the 50 symbol. Instead, the gaming system illustrates cycling or spinning symbols in each of the unlocked symbol display areas that are not revealing a generated symbol. In an alternative embodiment, the gaming system may continue to display each generated and displayed symbol as the gaming system moves to the next unlocked symbol display area (as discussed in connection with FIG. 4A-4I). It should also be appreciated that to create the cascading or waterfall effect, the gaming system generated and displayed a symbol in symbol display area 510b before 510k.

In FIG. 5E, the gaming system generated and displayed, from the bonus symbol set associated with symbol display area 510b, the 250 symbol. In this embodiment, the 250 symbol is also associated with a value of 250 credits. As shown in the information display area 505d, the gaming system updated the player's win meter to reflect the new 250 credit win (e.g., rising to 800 credits won in the bonus game). As also illustrated in FIG. 5E, the gaming system removed the previously revealed win from symbol display area 510f.

As illustrated in FIG. 5F, the gaming system generated and displayed, from the bonus symbol set associated with symbol display area 510k, the 10 symbol. In this embodiment, the 10 symbol is associated with a value of 10 credits. As shown in the information display area 505d, the gaming system updated the player's win meter to reflect the new 10 credit win (e.g., rising to 810 credits won in the bonus game).

As illustrated in FIG. 5G, the gaming system moved to symbol display area 510g. The gaming system generated and displayed, from the bonus symbol set associated with symbol display area 510g, the 1000 symbol. In this embodiment, the 1000 symbol is associated with a value of 1000 credits. As shown in the information display area 505d, the gaming system updated the player's win meter to reflect the new 1000 credit win (e.g., rising to 1810 credits won in the bonus game).

As illustrated in FIG. 5H, the gaming system moved to symbol display area 510l. The gaming system generated and displayed, from the bonus symbol set associated with symbol display area 510l, the 5 symbol. In this embodiment, the 5 symbol is associated with a value of 5 credits. As shown in the information display area 505d, the gaming system updated the player's win meter to reflect the new 5 credit win (e.g., rising to 1815 credits won in the bonus game). In FIG. 5H, the 5 symbol is also associated with the lock symbol (in accordance with the pay table from FIG. 8 associated with this game). Because the gaming system generated a lock symbol in unlocked symbol display area 510l, the gaming system also locked symbol display area 510l for the remainder of the game. In one embodiment, the gaming system does not generate another symbol from the associated bonus symbol set for display area 510l. However, it should be appreciated that in some embodiments, the gaming system may unlock symbol display area 510l if one or more triggering events occur (such as the gaming system generating a free spin award).

With the generation and display of the symbol in symbol display area 510l, the gaming system generated a first round of symbols from the associated bonus symbol sets for each of the initially unlocked symbol display areas. The gaming system evaluates the symbol display areas to determine if any symbol display area remains unlocked. As illustrated in FIG. 5H, five symbol display areas remain unlocked. As such, the gaming system continues to sequentially generate and display symbols for the unlocked symbol display areas. In one embodiment, the generation and display pattern remains the same. In alternative embodiments, the order in which the gaming system generates and displays symbols can be modified.

Returning to FIG. 5I, the gaming system returned to symbol display area 510a. The gaming system generated and displayed, from the bonus symbol set associated with symbol display area 510a, the 1000 symbol. In this embodiment, the 1000 symbol is associated with a value of 1000 credits. As shown in the information display area 505d, the gaming system updated the player's win meter to reflect the new 1000 credit win (e.g., rising to 2815 credits won in the bonus game). In this embodiment, the 1000 symbol is not associated with the lock symbol. Thus, symbol display area 510a remains unlocked for at least one additional symbol generation later in the game.

In FIG. 5J, the gaming system moved to symbol display area 510f again. The gaming system generated and displayed, from the bonus symbol set associated with symbol display area 510f, the 5 symbol. In this embodiment, the 5 symbol is associated with a value of 5 credits. As shown in the information display area 505d, the gaming system updated the player's win meter to reflect the new 5 credit win (e.g., rising to 2820 credits won in the bonus game). In this embodiment, the 5 symbol is associated with the lock symbol. Thus, symbol display area 510k becomes locked and cannot receive additional symbol generations for the remainder of the game.

For the sake of brevity, illustrations of the gaming system moving to symbol display areas 510b, 510k, and 510g are not shown. However, FIG. 5K illustrates that the gaming system generated the 5 symbol in each of the symbol display areas 510b, 510k, and 510g to lock these symbol display areas. As shown in the information display area 505d, the gaming system updated the player's win meter to reflect the new 5 credit wins (e.g., rising to 2835 credits won in the bonus game). Because the gaming system did not generate a lock symbol in symbol display area 510a, the symbol display area 510a remains unlocked for yet another generation and display of symbols from the associated bonus symbol set.

As shown in FIG. 5L, the gaming system generated the 5 symbol for symbol display area 510a in the next generation of symbols. As shown in the information display area 505d, the gaming system updated the player's win meter to reflect the new 5 credit win (e.g., rising to 2840 credits won in the bonus game). In this embodiment, the 5 symbol is associated with the lock symbol. Thus, symbol display area 510a remains locked for additional symbol generations later in the game.

In the illustrated embodiment, no unlocked symbol display areas remain. Therefore, the gaming system does not generate additional symbols for the symbol display areas from the bonus symbol set. The play of the game ends.

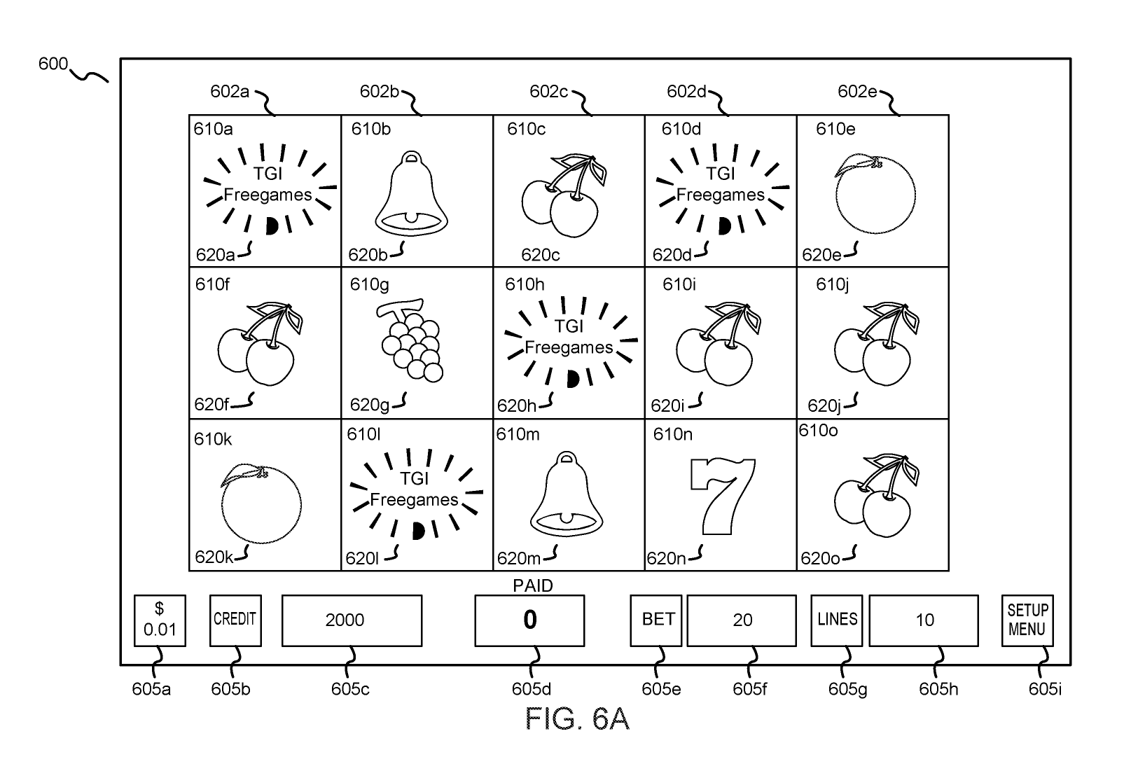

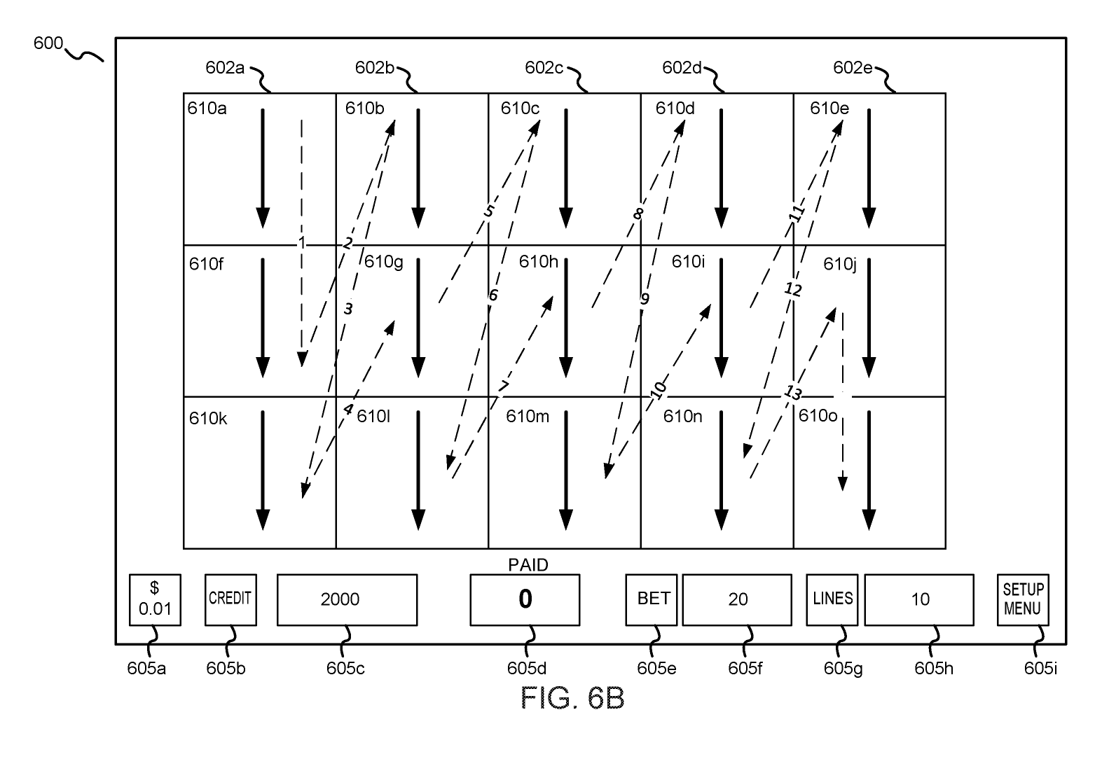

It should be appreciated that in the illustrated embodiment, the gaming system displayed the unlocked symbols in a sequential and in a cascading format. To further illustrate the sequential and cascading format, FIGS. 6A and 6B illustrate all of the reels and all of the symbol display areas being unlocked for the bonus game.

In FIG. 6A, the gaming system generated one TGI Freegames symbol (the bonus triggering symbol) in each of reels 602a, 602b, 602c, and 602d. In this embodiment, the gaming system unlocks all reels due to the generation of four bonus triggering symbols across four adjacent reels. It should be noted that the four bonus triggering symbols were not generated along an active pay line, but the gaming system still activates a bonus game (i.e., four bonus triggering symbols displayed anywhere on four adjacent reels). In some embodiments, one bonus triggering symbol unlocks one reel, thus five bonus triggering symbols may be required to unlock five reels.

FIG. 6B illustrates one embodiment of a sequential and cascading format for the bonus game. The gaming system unlocked all reels 602a, 602b, 602c, 602d, and 602e and all associated symbols display areas 610a, 610b, 610c, 610d, 610e, 610f, 610g, 610h, 610i, 610j, 610k, 610l, 610m, 610n, and 610o. The solid arrows in each of the symbols display areas 610a-610o illustrate the gaming system cycling or spinning symbols. The dashed line arrows 1, 2, 3, 4, 5, 6, 7, 8, 9, 10, 11, 12, 13, and 14 illustrate one order the gaming system uses to generate and display symbols in the unlocked symbol display areas 610a-610o. For example, the gaming system may generate and display symbols in the bonus game for symbol display position 610a then 610f. Subsequently, the gaming system may generate and display a symbol for symbol display position 610b. The gaming system may follow the numeric order of the dashed line arrows until generating and displaying a symbol for symbol display position 610o. It should be appreciated that in some embodiments, the gaming system may generate all of the symbols for display in their respective symbol display positions before displaying the generated symbols. As with the examples illustrated in FIGS. 4A-4I and 5A-5L, the gaming system may continue to generate symbols for any unlocked symbol display area, cycling through the symbol display areas in the order shown in FIG. 6B in successive cycles (but skipping over locked symbol display areas), until all symbol display areas are locked (or no unlocked symbol display areas remain).

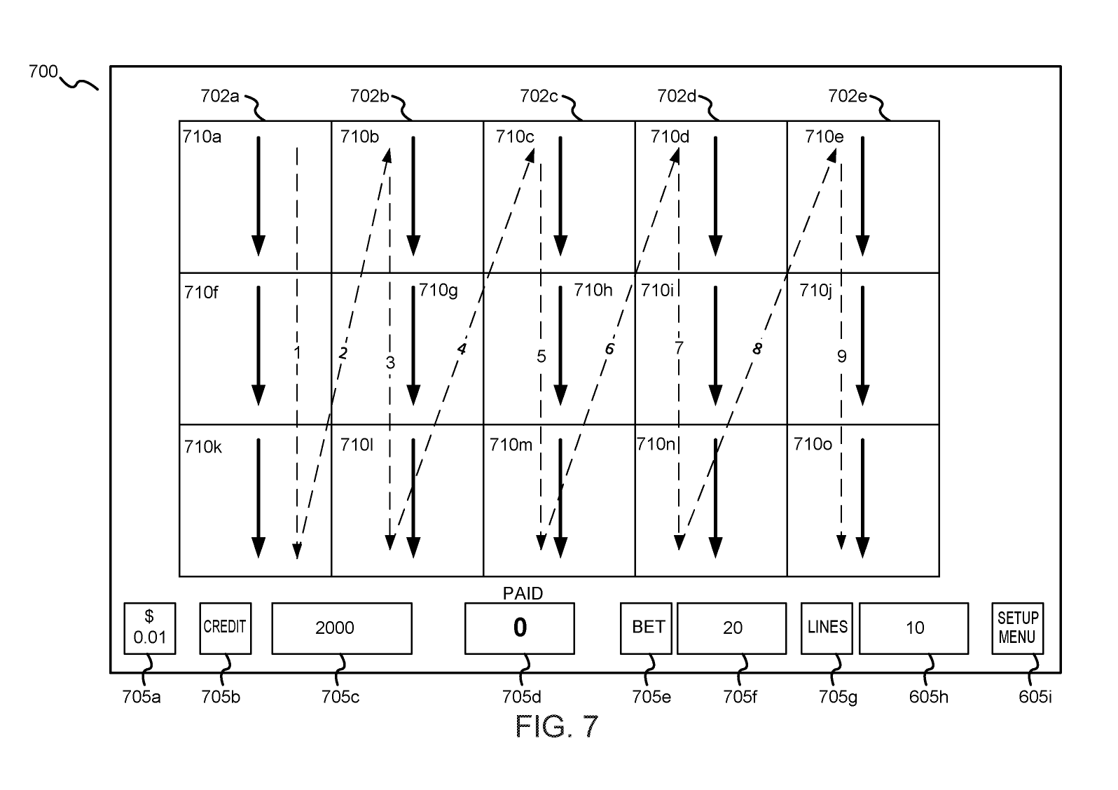

FIG. 7 is similar to FIG. 6B, except in FIG. 7, the order that the gaming system uses to generate and display the symbols differs from FIG. 6B. It should therefore be appreciated that the gaming system may generate and display the symbols in unlocked symbol display areas in any suitable format. In FIG. 7, the gaming system unlocked all reels 702a-702e and all associated symbols display areas 710a, 710b, 710c, 710d, 710e, 710f, 710g, 710h, 710i, 710j, 710k, 710l, 710m, 710n, and 710o. The solid arrows in each of the symbols display areas 710a-710o illustrate the gaming system cycling or spinning symbols. It should be appreciated that while the solid arrows show spinning in one direction, the spinning may occur in any direction. The dashed line arrows 1, 2, 3, 4, 5, 6, 7, 8, and 9 illustrate one order the gaming system may use to generate and display symbols in the unlocked symbol display areas 710a-710o. For example, the gaming system may generate and display symbols in the bonus game for symbol display positions 710a then 710f then 710k. Subsequently, the gaming system may generate and display a symbol for symbol display position 710b. The gaming system may follow the numeric order of the dashed line arrows until generating and displaying a symbol for symbol display position 710o. As with the examples illustrated in FIGS. 4A-4I, 5A-5L, and 6A-6B, the gaming system may continue to generate symbols for any unlocked symbol display area, cycling through the symbol display areas in the order shown in FIG. 7, until no unlocked symbol display areas remain.

Based on the forgoing description, it should be appreciated that a gaming system and method with a repeating free spin win accumulator creates new and very exciting ways for a player to obtain winning symbols with a potential to earn frequent and greater awards. The gaming system increases volatility and excitement for players in embodiments where award amounts are not predetermined, activations of the repeating free spin win accumulator are frequent, and there are no losing outcomes. Such a potential to earn greater awards creates a greatly improved sense of anticipation for players.

A number of embodiments of the invention have been described. Various modifications may be made without departing from the spirit and scope of the invention. For example, various forms of the flows shown above may be used, with steps re-ordered, added, or removed. Accordingly, other embodiments are within the scope of the following claims.

1. A gaming system comprising:
a cabinet;
a processor;
a display device supported by the cabinet;
an input device supported by the cabinet;
a value acceptor supported by the cabinet;
a value dispenser supported by the cabinet;
a memory device that stores a plurality of instructions which, when executed by the processor, cause the processor to:
establish a credit balance based at least in part on a monetary value received by the value acceptor;
place a wager following receipt of a wager input via an input device, the credit balance being decreased by the wager;
display, on the display device, a plurality of randomly generated symbols from a first set of symbols;
determine if at least one trigger symbol was generated from the first set of symbols;
display, on the display device, in response to the at least one trigger symbol, a plurality of unlocked symbol display areas, each unlocked symbol display area being associated with one of a plurality of second sets of symbols, where each of the plurality of second sets of symbols comprises at least one lock symbol;
for each unlocked symbol display area, randomly generate a first symbol from the associated one of the plurality of second sets of symbols;
display, on the display device, for each unlocked symbol display area, the randomly generated symbols from the associated one of the plurality of second sets of symbols;
display, on the display device, to display any determined awards, the credit balance being increased by any determined awards;
lock any unlocked symbol display area where the at least one lock symbol was generated and displayed;
for each remaining unlocked symbol display area, randomly generate a second symbol from the associated one of the plurality of second sets of symbols;
display, on the display device, any determined awards, the credit balance being increased by any determined awards; and
issue value from the value dispenser based on the credit balance upon receipt of a cash out signal via the input device.

2. The gaming system of claim 1, wherein the at least one trigger symbol triggers a bonus game.

3. The gaming system of claim 2, wherein the plurality of unlocked symbol display areas are in the bonus game.

4. The gaming system of claim 1, wherein if one trigger symbol was generated, the processor further displays a first quantity of the plurality of unlocked symbol display areas, and wherein if two trigger symbols were generated, the processor further displays a second quantity of the plurality of unlocked symbol display areas.

5. The gaming system of claim 4, wherein the first quantity of the plurality of unlocked symbol display areas is different from the second quantity of the plurality of unlocked symbol display areas.

6. The gaming system of claim 4, wherein the first quantity of the plurality of unlocked symbol display areas is lower than the second quantity of the plurality of unlocked symbol display areas.

7. The gaming system of claim 1, wherein generating a larger quantity of trigger symbols results in the processor generating a larger quantity of the unlocked symbol display areas than generating a smaller quantity of trigger symbols.

8. The gaming system of claim 1, wherein the plurality of unlocked symbol display areas are displayed in a bonus game.

9. The gaming system of claim 1, wherein the symbols in the plurality of second sets of symbols are each associated with values greater than zero.

10. The gaming system of claim 1, wherein the processor displays the randomly generated symbols from the associated one of the plurality of second sets of symbols in a predetermined sequence.

11. The gaming system of claim 10, wherein the predetermined sequence comprises a cascading sequence where the processor initially displays one of the randomly generated symbols from the associated one of the plurality of second sets of symbols on one side of the display before sequentially displaying each additional ones of the randomly generated symbols from the associated one of the plurality of second sets of symbols.

12. The gaming system of claim 1, wherein at least one symbol in the plurality of second sets of symbols is associated with a nonmonetary award.

13. The gaming system of claim 1, wherein the symbols in the plurality of second sets of symbols are each associated with a value greater than zero and the at least one lock symbol is a lowest value symbol in the plurality of second sets of symbols.

14. The gaming system of claim 1, wherein the symbols in the plurality of second sets of symbols are each associated with a value greater than zero and one of the symbols in each of the plurality of second sets of symbols is randomly designated as the at least one lock symbol.

15. The gaming system of claim 1, wherein the at least one lock symbol is associated with a value.

16. The gaming system of claim 1, wherein until each of the plurality of unlocked symbol display areas are locked, the processor will continue to:
randomly generate another symbol from the associated one of the plurality of second sets of symbols for each remaining unlocked symbol display area;
display, on the display device, for each unlocked symbol display area, the randomly generated symbols from the associated one of the plurality of second sets of symbols;
cause the credit balance to increase by any determined awards; and
lock any unlocked symbol display area where the at least one lock symbol was generated and displayed.

17. The gaming system of claim 1, wherein the processor increases a quantity of symbols in the plurality of second sets of symbols that are associated with high values when the wager amount is increased.

18. The gaming system of claim 1, wherein the processor randomly generates another symbol from the associated one of the plurality of second sets of symbols for each remaining unlocked symbol display area a predetermined number of times.

19. A method of operating a gaming system, the method comprising:
receiving, by a monetary value acceptor, a monetary value;
establishing, by a processor of the gaming system, a credit balance based at least in part on the received monetary value;
accepting, from an input device in a housing of the gaming system, a wager amount;
decreasing, by the processor, the credit balance by the wager amount;
displaying, on a display device of the housing, a plurality of randomly generated symbols from a first set of symbols;
determining if at least one trigger symbol was generated from the first set of symbols;
displaying, on the display device, in response to the at least one trigger symbol, a plurality of unlocked symbol display areas, each unlocked symbol display area being associated with one of a plurality of second sets of symbols, where each of the plurality of second sets of symbols comprises at least one lock symbol;
for each unlocked symbol display area, randomly generating a first symbol from the associated one of the plurality of second sets of symbols;
displaying, on the display device, for each unlocked symbol display area, the randomly generated symbols from the associated one of the plurality of second sets of symbols;
displaying, on the display device, any determined awards, the credit balance being increased by any determined awards;
locking any unlocked symbol display area where the at least one lock symbol was generated and displayed;
for each remaining unlocked symbol display area, randomly generating a second symbol from the associated one of the plurality of second sets of symbols;
displaying, on the display device, any determined awards;
increasing, by the processor, the credit balance by any determined awards; and
issuing another monetary value, by the value dispenser, based on the credit balance upon receipt of a cash out signal via an input device of the gaming system.

20. A non-transitory computer-readable storage medium having machine instructions stored therein, the instructions being executable by a processor to cause the processor to:
establish a credit balance based at least in part on a monetary value received by a value acceptor of a gaming device;
place a wager following receipt of a wager input via an input device, the credit balance being decreased by the wager;
display, on the display device, a plurality of randomly generated symbols from a first set of symbols;
determine if at least one trigger symbol was generated from the first set of symbols;
display, on the display device, in response to the at least one trigger symbol, a plurality of unlocked symbol display areas, each unlocked symbol display area being associated with one of a plurality of second sets of symbols, where each of the plurality of second sets of symbols comprises at least one lock symbol;
for each unlocked symbol display area, randomly generate a first symbol from the associated one of the plurality of second sets of symbols;
display, on the display device, for each unlocked symbol display area, the randomly generated symbols from the associated one of the plurality of second sets of symbols;
cause the display device to display any determined awards, the credit balance being increased by any determined awards;
lock any unlocked symbol display area where the at least one lock symbol was generated and displayed;
for each remaining unlocked symbol display area, randomly generate a second symbol from the associated one of the plurality of second sets of symbols;
display, with the display device, any determined awards, the credit balance being increased by any determined awards; and
issue value from a value dispenser based on the credit balance upon receipt of a cash out signal via the input device.
